(19) United States
(12) Patent Application Publication
(10) Pub. No.: US 2023/0212988 A1
(43) Pub. Date: Jul. 6, 2023

(54) VERSATILE CONTROL OF A PROPULSION SYSTEM WITH A FUEL CELL

(71) Applicant: General Electric Company, Schenectady, NY (US)

(72) Inventors: Honggang Wang, Clifton Park, NY (US); Michael Anthony Benjamin, Cincinnati, OH (US)

(21) Appl. No.: 17/568,099

(22) Filed: Jan. 4, 2022

(51) Int. Cl. B64D 31/00; B64D 27/24; H01M 8/04701; H01M 8/04858; B64D 37/00; B64D 27/10; B60L 58/30; B64D 27/02

(52) U.S. Cl. CPC B64D 31/00; B64D 27/24; H01M 8/04701; H01M 8/04895; B64D 37/00; H01M 8/04925; B64D 27/10; B60L 58/30; B64D 2027/026; H01M 2250/20; B60L 2200/10

(57) ABSTRACT

A propulsion system for an aircraft includes a fuel cell assembly, the fuel cell assembly including a fuel cell, and a turbomachine, the turbomachine including a compressor section, a combustor, and a turbine section arranged in serial flow order. The combustor is configured to receive a flow of fuel and further configured to receive output products from the fuel cell. A controller is configured to receive data indicative of an engine constraint of the turbomachine, determine that the engine constraint has achieved a fuel cell trim threshold; and perform a fuel cell corrective action with the fuel cell assembly in response to determining that the engine constraint has achieved the fuel cell trim threshold.

### FIELD

The present disclosure relates to a system and method for versatile control of the propulsion system of a gas turbine engine, the propulsion system including a fuel cell.

### BACKGROUND

A gas turbine engine generally includes a turbomachine and a rotor assembly. Gas turbine engines, such as turbofan engines, may be used for aircraft propulsion. In the case of a turbofan engine, the turbomachine includes a compressor section, a combustion section, and a turbine section in serial flow order, and the rotor assembly is configured as a fan assembly. The available degrees of freedom to alleviate combustor operability issues may dictate operability ranges of engines. Engines may face various limitations based on a number of degrees of freedom available to control operability issues.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a perspective view of an integrated fuel cell and combustor assembly in accordance with the present disclosure.

FIG. 3 is a schematic, axial view of the exemplary integrated fuel cell and combustor assembly of FIG. 2.

FIG. 4 is a schematic view of a fuel cell of a fuel cell assembly in accordance with an exemplary aspect of the present disclosure as may be incorporated into the exemplary integrated fuel cell and combustor assembly of FIG. 2.

FIG. 5 is a schematic diagram of a gas turbine engine including an integrated fuel cell and combustor assembly in accordance with an exemplary aspect of the present disclosure.

FIG. 6 is a schematic view of a vehicle and propulsion system in accordance with an exemplary aspect of the present disclosure.

FIG. 7 is a flow diagram depicting control of a fuel cell subsystem based on one or more engine constraints in accordance with an exemplary aspect of the present disclosure.

FIG. 8 is a chart depicting an operability indicator of one or more engine constraints in accordance with an exemplary aspect of the present disclosure.

FIG. 9 is a chart depicting an operability indicator of a plurality of engine constraints in accordance with an exemplary aspect of the present disclosure.

FIG. 10 is a schematic representation of a control system in accordance with an exemplary aspect of the present disclosure.

FIG. 11 is a schematic representation of a control system in accordance with another exemplary aspect of the present disclosure.

FIG. 12 is a schematic representation of a control system in accordance with yet another exemplary aspect of the present disclosure.

FIG. 13 is a flow diagram depicting a method of operating a propulsion system in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” or “at least one of A, B, or C” refers to only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

A system and method are provided for operating a propulsion system for an aircraft. The propulsion system includes a fuel cell assembly comprising a fuel cell, the fuel cell defining an outlet positioned to remove output products from the fuel cell. The propulsion system further includes a turbomachine, the turbomachine including a combustion section configured to receive a flow of aviation fuel from an aircraft fuel supply of the aircraft and further configured to receive the output products from the fuel cell. The system and method are generally configured to provide versatile control of such an aircraft by configuring the fuel cell assembly to respond with corrective action to account for engine constraints exceeding certain thresholds.

A system and method of the present disclosure may generally result in efficient management of engine constraints by leveraging operational effects of a fuel cell assembly integrated into the combustor assembly. Such an increase in availability of potential actuators to control these engine constraints by further controlling the fuel cell assembly may provide greater operability ranges and efficient running without requiring any, or only requiring minimal, additional structure and complication for the engine.

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolytes.

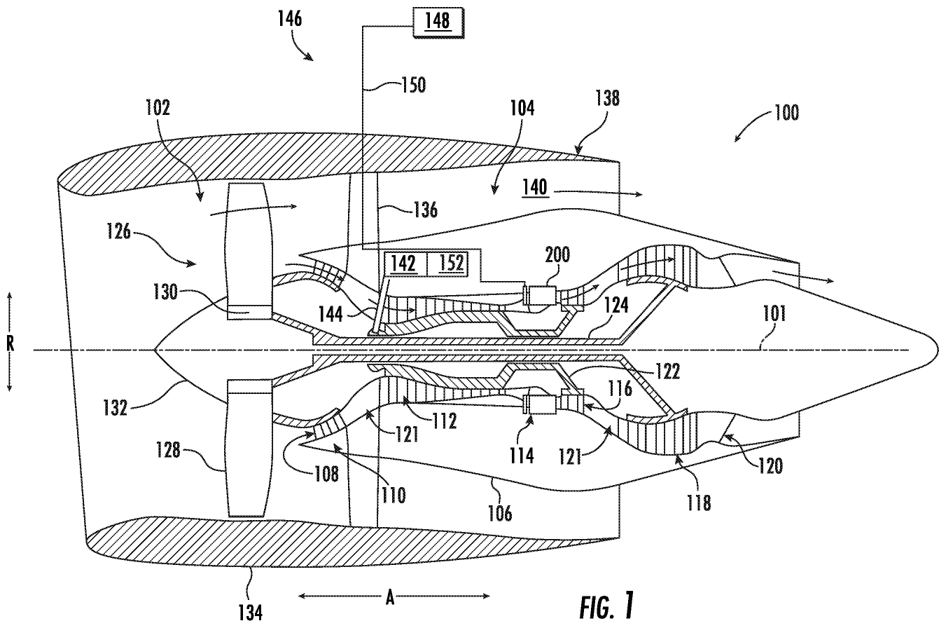

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable vehicle.

For the embodiment depicted, the engine is configured as a high bypass turbofan engine 100. As shown in FIG. 1, the turbofan engine 100 defines an axial direction A (extending parallel to a centerline axis 101 provided for reference), a radial direction R, and a circumferential direction (extending about the axial direction A; not depicted in FIG. 1). In general, the turbofan engine 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the centerline axis 101 by the LP shaft 124. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

In such a manner, it will be appreciated that turbofan engine 100 generally includes a first stream (e.g., core air flowpath 121) and a second stream (e.g., bypass airflow passage 140) extending parallel to the first stream. In certain exemplary embodiments, the turbofan engine 100 may further define a third stream extending, e.g., from the LP compressor 110 to the bypass airflow passage 140 or to ambient. With such a configuration, the LP compressor 110 may generally include a first compressor stage configured as a ducted mid-fan and downstream compressor stages. An inlet to the third stream may be positioned between the first compressor stage and the downstream compressor stages.

Referring still to FIG. 1, the turbofan engine 100 additionally includes an accessory gearbox 142 and a fuel delivery system 146. For the embodiment shown, the accessory gearbox 142 is located within the cowling/outer casing 106 of the turbomachine 104. Additionally, it will be appreciated that for the embodiment depicted schematically in FIG. 1, the accessory gearbox 142 is mechanically coupled to, and rotatable with, one or more shafts or spools of the turbomachine 104. For example, in the exemplary embodiment depicted, the accessory gearbox 142 is mechanically coupled to, and rotatable with, the HP shaft 122 through a suitable geartrain 144. The accessory gearbox 142 may provide power to one or more suitable accessory systems of the turbofan engine 100 during at least certain operations, and may further provide power back to the turbofan engine 100 during other operations. For example, the accessory gearbox 142 is, for the embodiment depicted, coupled to a starter motor/generator 152. The starter motor/generator may be configured to extract power from the accessory gearbox 142 and turbofan engine 100 during certain operation to generate electrical power, and may provide power back to the accessory gearbox 142 and turbofan engine 100 (e.g., to the HP shaft 122) during other operations to add mechanical work back to the turbofan engine 100 (e.g., for starting the turbofan engine 100).

Moreover, the fuel delivery system 146 generally includes a fuel source 148, such as a fuel tank, and one or more fuel delivery lines 150. The one or more fuel delivery lines 150 provide a fuel flow through the fuel delivery system 146 to the combustion section 114 of the turbomachine 104 of the turbofan engine 100. As will be discussed in more detail below, the combustion section 114 includes an integrated fuel cell and combustor assembly 200. The one or more fuel delivery lines 150, for the embodiment depicted, provide a flow of fuel to the integrated fuel cell and combustor assembly 200.

It will be appreciated, however, that the exemplary turbofan engine 100 depicted in FIG. 1 is provided by way of example only. In other exemplary embodiments, any other suitable gas turbine engine may be utilized with aspects of the present disclosure. For example, in other embodiments, the turbofan engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine, in other embodiments, a gas turbine engine of the present disclosure may be a geared gas turbine engine (i.e., including a gearbox between the fan 126 and a shaft driving the fan, such as the LP shaft 124), may be a variable pitch gas turbine engine (i.e., including a fan 126 having a plurality of fan blades 128 rotatable about their respective pitch axes), etc. Moreover, although the exemplary turbofan engine 100 includes a ducted fan 126, in other exemplary aspects, the turbofan engine 100 may include an unducted fan 126 (or open rotor fan), without the nacelle 134. Further, although not depicted herein, in other embodiments the gas turbine engine may be any other suitable type of gas turbine engine, such as a nautical gas turbine engine.

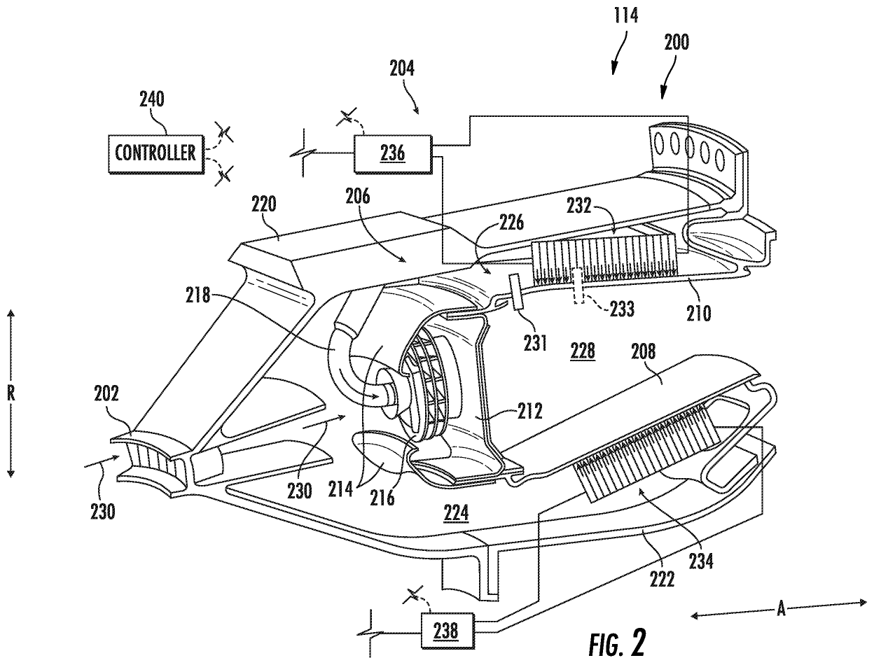

Referring now to FIG. 2, illustrated schematically is a portion of the combustion section 114 including a portion of the integrated fuel cell and combustor assembly 200 used in the gas turbine engine 100 of FIG. 1 (described as a turbofan engine 100 above with respect to FIG. 1), according to an embodiment of the present disclosure.

As will be appreciated, the combustion section 114 includes a compressor diffuser nozzle 202 and extends between an upstream end and a downstream end generally along the axial direction A. The combustion section 114 is fluidly coupled to the compressor section at the upstream end via the compressor diffuser nozzle 202 and to the turbine section at the downstream end.

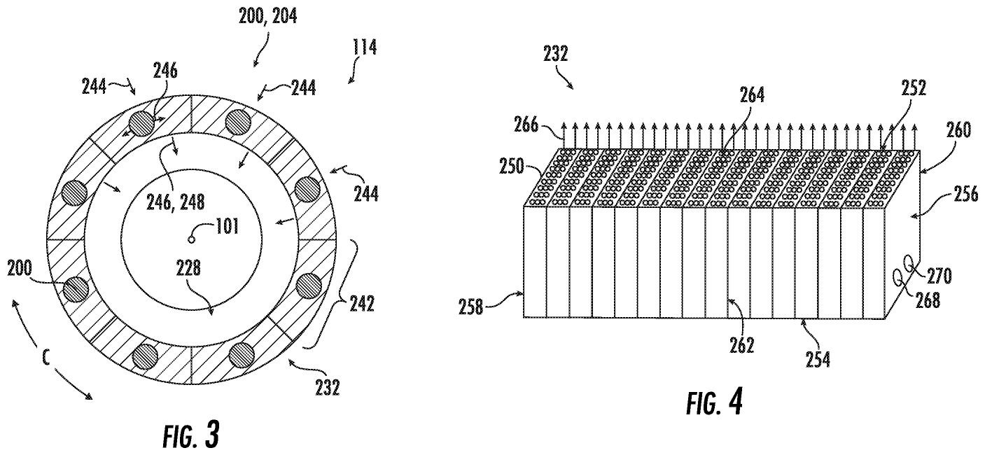

The integrated fuel cell and combustor assembly 200 generally includes a fuel cell assembly 204 (only partially depicted in FIG. 2; see also FIGS. 3 through 5) and a combustor 206. The combustor 206 includes an inner liner 208, an outer liner 210, a dome assembly 212, a cowl assembly 214, a swirler assembly 216, and a fuel flowline 218. The combustion section 114 generally includes an outer casing 220 outward of the combustor 206 along the radial direction R to enclose the combustor 206 and an inner casing 222 inward of the combustor 206 along the radial direction R. The inner casing 222 and inner liner 208 define an inner passageway 224 therebetween, and the outer casing 220 and outer liner 210 define an outer passageway 226 therebetween. The inner casing 222, the outer casing 220, and the dome assembly 212 together define at least in part a combustion chamber 228 of the combustor 206.

The dome assembly 212 is disposed proximate the upstream end of the combustion section 114 (i.e., closer to the upstream end than the downstream end) and includes an opening (not labeled) for receiving and holding the swirler assembly 216. The swirler assembly 216 also includes an opening for receiving and holding the fuel flowline 218. The fuel flowline 218 is further coupled to the fuel source 148 (see FIG. 1) disposed outside the outer casing 220 along the radial direction R and configured to receive the fuel from the fuel source 148. In such a manner, the fuel flowline 218 may be fluidly coupled to the one or more fuel delivery lines 150 described above with reference to FIG. 1.

The swirler assembly 216 can include a plurality of swirlers (not shown) configured to swirl the compressed fluid before injecting it into the combustion chamber 228 to generate combustion gas. The cowl assembly 214, in the embodiment depicted, is configured to hold the inner liner 208, the outer liner 210, the swirler assembly 216, and the dome assembly 212 together.

During operation, the compressor diffuser nozzle 202 is configured to direct a compressed fluid 230 from the compressor section to the combustor 206, where the compressed fluid 230 is configured to be mixed with fuel within the swirler assembly 216 and combusted within the combustion chamber 228 to generate combustion gasses. The combustion gasses are provided to the turbine section to drive one or more turbines of the turbine section (e.g., the high pressure turbine 116 and low pressure turbine 118).

During operation of the gas turbine engine 100 including the integrated fuel cell and combustor assembly 200, a flame within the combustion chamber 228 is maintained by a continuous flow of fuel and air. In order to provide for an ignition of the fuel and air, e.g., during a startup of the gas turbine engine 100, the integrated fuel cell and combustor assembly 200 further includes an ignitor 231. The ignitor 231 may provide a spark or initial flame to ignite a fuel and air mixture within the combustion chamber 228. In certain exemplary embodiments, the integrated fuel cell and combustor assembly 200 may additionally include a dedicated fuel cell ignitor 233 (depicted in phantom). In particular, for the embodiment of FIG. 2, the dedicated fuel cell ignitor 233 is positioned downstream of at least a portion of a fuel cell, and in particular of a fuel cell stack (described below). In such a manner, the dedicated fuel cell ignitor 233 may more effectively combust output products of the fuel cell.

As mentioned above and depicted schematically in FIG. 2, the integrated fuel cell and combustor assembly 200 further includes the fuel cell assembly 204. The exemplary fuel cell assembly 204 depicted includes a first fuel cell stack 232 and a second fuel cell stack 234. More specifically, the first fuel cell stack 232 is configured with the outer liner 210 and the second fuel cell stack 234 is configured with the inner liner 208. More specifically, still, the first fuel cell stack 232 is integrated with the outer liner 210 and the second fuel cell stack 234 is integrated with the inner liner 208. Operation of the fuel cell assembly 204, and more specifically of a fuel cell stack (e.g., first fuel cell stack 232 or second fuel cell stack 234) of the fuel cell assembly 204 will be described in more detail below.

For the embodiment depicted, the fuel cell assembly 204 is configured as a solid oxide fuel cell (“SOFC”) assembly, with the first fuel cell stack 232 configured as a first SOFC fuel cell stack and the second fuel cell stack 234 configured as a second SOFC fuel cell stack (each having a plurality of SOFC's). As will be appreciated, a SOFC is generally an electrochemical conversion device that produces electricity directly from oxidizing a fuel. In general, fuel cell assemblies, and in particular fuel cells, are characterized by an electrolyte material utilized. The SOFC's of the present disclosure may generally include a solid oxide or ceramic electrolyte. This class of fuel cells generally exhibit high combined heat and power efficiency, long-term stability, fuel flexibility, and low emissions.

Moreover, the exemplary fuel cell assembly 204 further includes a first power converter 236 and a second power converter 238. The first fuel cell stack 232 is in electrical communication with the first power converter 236 by a first plurality of power supply cables (not labeled), and the second fuel cell stack 234 is in electrical communication with the second power converter 238 by a second plurality of power supply cables (not labeled).

The first power converter 236 controls the electrical current drawn from the corresponding first fuel cell stack 232 and may convert the electrical power from a direct current (“DC”) power to either DC power at another voltage level or alternating current (“AC”) power. Similarly, the second power converter 238 controls the electrical current drawn from the second fuel cell stack 234 and may convert the electrical power from a DC power to either DC power at another voltage level or AC power. The first power converter 236, the second power converter 238, or both may be electrically coupled to an electric bus (such as the electric bus 326 described below).

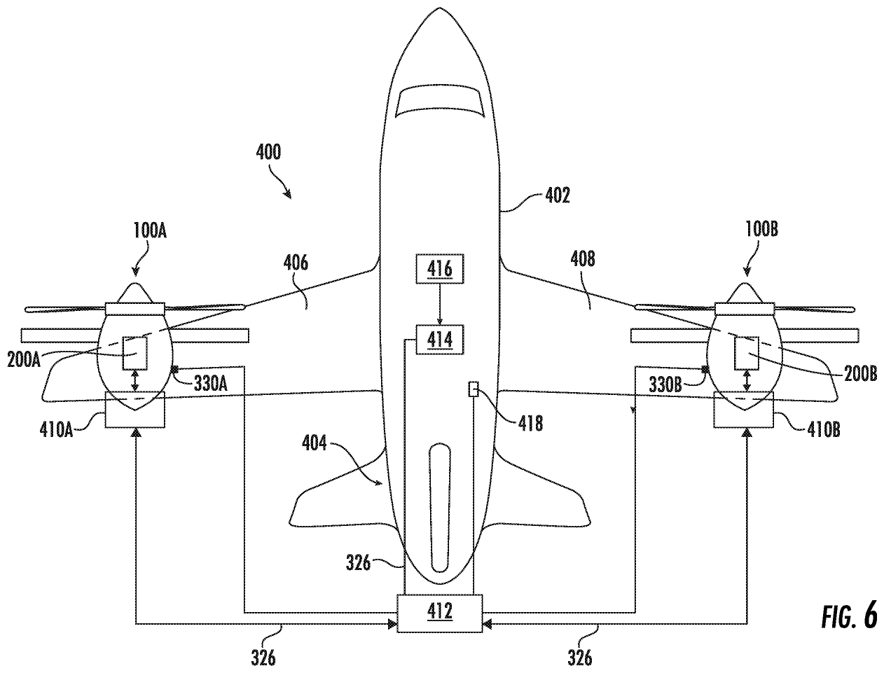

The integrated fuel cell and combustor assembly 200 further includes a fuel cell controller 240 that is in operable communication with both of the first power converter 236 and second power converter 238 to, e.g., send and receive communications and signals therebetween. For example, the fuel cell controller 240 may send current or power setpoint signals to the first power converter 236 and second power converter 238, and may receive, e.g., a voltage or current feedback signal from the first power converter 236 and second power converter 238. The fuel cell controller 240 may be configured in the same manner as the controller 240 described below with reference to FIG. 5. In one or more embodiments, the controller 240 may refer collectively to a plurality of controllers configured to communicate with one another.

It will be appreciated that in at least certain exemplary embodiments the first fuel cell stack 232, the second fuel cell stack 234, or both may extend substantially 360 degrees in a circumferential direction C of the gas turbine engine (i.e., a direction extending about the centerline axis 101 of the gas turbine engine 100). For example, referring now to FIG. 3, a simplified cross-sectional view of the integrated fuel cell and combustor assembly 200 is depicted according to an exemplary embodiment of the present disclosure. Although only the first fuel cell stack 232 is depicted in FIG. 3 for simplicity, the second fuel cell stack 234 may be configured in a similar manner.

As shown, the first fuel cell stack 232 extends around the combustion chamber 228 in the circumferential direction C, completely encircling the combustion chamber 228 around the centerline axis 101 in the embodiment shown. More specifically, the first fuel cell stack 232 includes a plurality of fuel cells 242 arranged along the circumferential direction C. The fuel cells 242 that are visible in FIG. 3 can be a single ring of fuel cells 242, with fuel cells 242 stacked together along the axial direction A (see FIG. 2) to form the first fuel cell stack 232. In another instance, multiple additional rings of fuel cells 242 can be placed on top of each other to form the first fuel cell stack 232 that is elongated along the centerline axis 101.

As will be explained in more detail, below, with reference to FIG. 5, the fuel cells 242 in the first fuel cell stack 232 are positioned to receive discharged air 244 from, e.g., the compressor section and fuel 246 from the fuel delivery system 146. The fuel cells 242 generate electrical current using this air 244 and at least some of this fuel 246, and radially direct partially oxidized fuel 246 and unused portion of air 248 into the combustion chamber 228 toward the centerline axis 101. The integrated fuel cell and combustor assembly 200 combusts the partially oxidized fuel 246 and air 248 in the combustion chamber 228 into combustion gasses that are directed downstream into the turbine section to drive or assist with driving the one or more turbines therein.

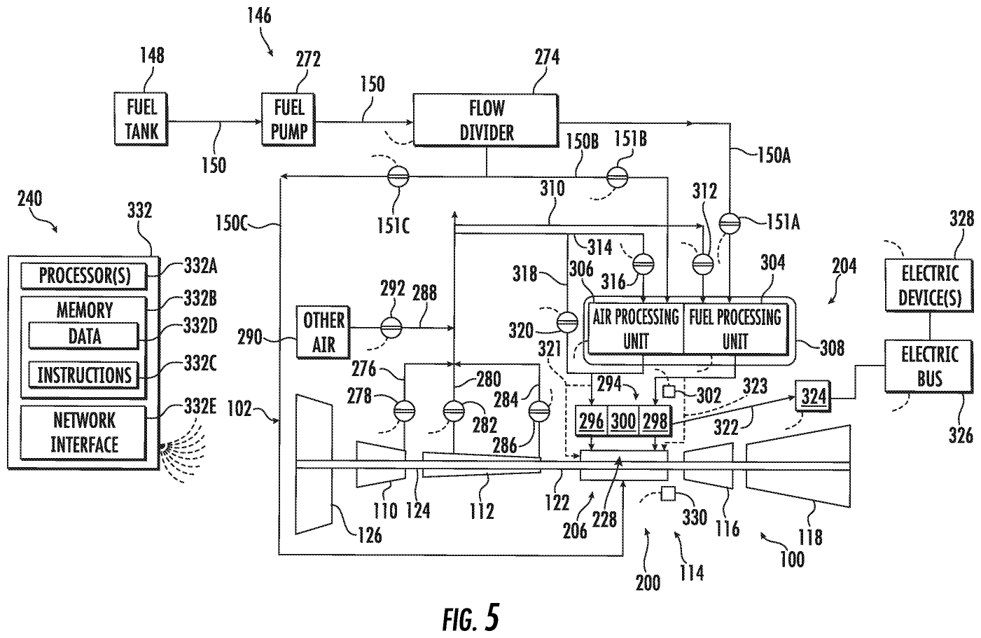

Moreover, referring now to FIG. 4, a schematic illustration is provided as a perspective view of the first fuel cell stack 232 of the integrated fuel cell and combustor assembly 200 of FIG. 2. The second fuel cell stack 234 may be formed in a similar manner.

The first fuel cell stack 232 depicted includes a housing 250 having a combustion outlet side 252 and a side 254 that is opposite to the combustion outlet side 252, a fuel and air inlet side 256 and a side 258 that is opposite to the fuel and air inlet side 256, and sides 260, 262. The side 260, the side 258 and the side 254 are not visible in the perspective view of FIG. 4.

As will be appreciated, the first fuel cell stack 232 may include a plurality of fuel cells that are “stacked,” e.g., side-by-side from one end of the first fuel cell stack 232 (e.g., fuel and air inlet side 256) to another end of the first fuel cell stack 232 (e.g., side 258). As such, it will further be appreciated that the combustion outlet side 252 includes a plurality of combustion outlets 264, each from a fuel cell of the first fuel cell stack 232. During operation, combustion gas 266 (also referred to herein as “output products”) is directed from the combustion outlets 264 out of the housing 250. As described herein, the combustion gas 266 is generated using fuel and air that is not consumed by the fuel cells inside the housing 250 of the first fuel cell stack 232. The combustion gas 266 is provided to the combustion chamber 228 and burned during operation to generate combustion gasses used to generate thrust for the gas turbine engine 100 (and vehicle/aircraft incorporating the gas turbine engine 100).

The fuel and air inlet side 256 includes one or more fuel inlets 268 and one or more air inlets 270. Optionally, one or more of the inlets 268, 270 can be on another side of the housing 250. Each of the one or more fuel inlets 268 is fluidly coupled with a source of fuel for the first fuel cell stack 232, such as one or more pressurized containers of a hydrogen-containing gas or a fuel processing unit as described further below. Each of the one or more air inlets 270 is fluidly coupled with a source of air for the fuel cells, such as air that is discharged from a compressor section and/or an air processing unit as is also described further below. The one or more inlets 268, 270 separately receive the fuel and air from the external sources of fuel and air, and separately direct the fuel and air into the fuel cells.

In certain exemplary embodiments, the first fuel cell stack 232 of FIGS. 2 through 4 may be configured in a similar manner to one or more of the exemplary fuel cell systems (labeled 100) described in, e.g., U.S. Patent Application Publication No. 2020/0194799 A1, filed Dec. 17, 2018, that is incorporated by reference herein in its entirety. It will further be appreciated that the second fuel cell stack 234 of FIG. 2, may be configured in a similar manner as the first fuel cell stack 232, or alternatively may be configured in any other suitable manner.

Referring now to FIG. 5, operation of an integrated fuel cell and combustor assembly 200 in accordance with an exemplary embodiment of the present disclosure will be described. More specifically, FIG. 5 provides a schematic illustration of a gas turbine engine 100 and an integrated fuel cell and combustor assembly 200 according to an embodiment of the present disclosure. The gas turbine engine 100 and integrated fuel cell and combustor assembly 200 may, in certain exemplary embodiments, be configured in a similar manner as one or more of the exemplary embodiments of FIGS. 1 through 4.

Accordingly, it will be appreciated that the gas turbine engine 100 generally includes a fan section 102 having a fan 126, an LP compressor 110, an HP compressor 112, a combustion section 114, an HP turbine 116, and an LP turbine 118. The combustion section 114 generally includes the integrated fuel cell and combustor assembly 200 having a combustor 206 and a fuel cell assembly 204.

A propulsion system including the gas turbine engine 100 further includes a fuel delivery system 146. The fuel delivery system 146 generally includes a fuel source 148 and one or more fuel delivery lines 150. The fuel source 148 may include a supply of fuel (e.g., a hydrocarbon fuel, including, e.g., a carbon-neutral fuel or synthetic hydrocarbons) for the gas turbine engine 100. In addition, it will be appreciated that the fuel delivery system 146 also includes a fuel pump 272 and a flow divider 274, and the one or more fuel delivery lines 150 include a first fuel delivery line 150A, a second fuel delivery line 150B, and a third fuel delivery line 150C. The flow divider 274 divides the fuel flow from the fuel source 148 and fuel pump 272 into a first fuel flow through the first fuel delivery line 150A to the fuel cell assembly 204, a second fuel flow through the second fuel delivery line 150B also to the fuel cell assembly 204 (and in particular to an air processing unit, described below), and a third fuel flow through a third fuel delivery line 150C to the combustor 206. The flow divider 274 may include a series of valves (not shown) to facilitate such dividing of the fuel flow from the fuel source 148, or alternatively may be of a fixed geometry. Additionally, for the embodiment shown, the fuel delivery system 146 includes a first fuel valve 151A associated with the first fuel delivery line 150A (e.g., for controlling the first fuel flow), a second fuel valve 151B associated with the second fuel delivery line 150B (e.g., for controlling the second fuel flow), and a third fuel valve 151C associated with the third fuel delivery line 150C (e.g., for controlling the third fuel flow).

The gas turbine engine 100 further includes a compressor bleed system and an airflow delivery system. More specifically, the compressor bleed system includes an LP bleed air duct 276 and an associated LP bleed air valve 278, an HP bleed air duct 280 and an associated HP bleed air valve 282, an HP exit air duct 284 and an associated HP exit air valve 286.

The gas turbine engine 100 further includes an air stream supply duct 288 (in airflow communication with an airflow supply 290) and an associated air valve 292, which is also in airflow communication with the airflow delivery system for providing compressed airflow to the fuel cell assembly 204 of the integrated fuel cell and combustor assembly 200. The airflow supply may be, e.g., a second gas turbine engine configured to provide a cross-bleed air, an auxiliary power unit (APU) configured to provide a bleed air, a ram air turbine (RAT), etc. The airflow supply may be complimentary to the compressor bleed system if the compressor air source is inadequate or unavailable.

The compressor bleed system (and air stream supply duct 288) is in airflow communication with airflow delivery system for providing compressed airflow to the fuel cell assembly 204, as will be explained in more detail below.

Referring still to FIG. 5, the fuel cell assembly 204 of the integrated fuel cell and combustor assembly 200 includes a fuel cell stack 294, which may be configured in a similar manner as, e.g., the first fuel cell stack 232 described above. The fuel cell stack 294 is depicted schematically as a single fuel cell having a cathode side 296, an anode side 298, and an electrolyte 300 positioned therebetween. As will generally be appreciated, the electrolyte 300 may, during operation, conduct negative oxygen ions from the cathode side 296 to the anode side 298 to generate an electric current and electric power.

Briefly, it will be appreciated that the fuel cell assembly 204 further includes a fuel cell sensor 302 configured to sense data indicative of a fuel cell assembly operating parameter, such as a temperature of the fuel cell stack 294 (e.g., of the cathode side 296 or anode side 298 of the fuel cell), a pressure within the fuel cell stack 294 (e.g., of within the cathode side 296 or anode side 298 of the fuel cell), and/or a composition (e.g., a chemical composition) of the output products from the fuel cell assembly 204.

The anode side 298 may support electrochemical reactions that generate electricity. A fuel may be oxidized in the anode side 298 with oxygen ions received from the cathode side 296 via diffusion through the electrolyte 300. The reactions may create heat, steam, and electricity in the form of free electrons in the anode side 298, which may be used to supply power to an energy consuming device (such as the one or more additional electric devices 328 described below). The oxygen ions may be created via an oxygen reduction of a cathode oxidant using the electrons returning from the energy consuming device into the cathode side 296.

The cathode side 296 may be coupled to a source of the cathode oxidant, such as oxygen in the atmospheric air. The cathode oxidant is defined as the oxidant that is supplied to the cathode side 296 employed by the fuel cell system in generating electrical power. The cathode side 296 may be permeable to the oxygen ions received from the cathode oxidant.

The electrolyte 300 may be in communication with the anode side 298 and the cathode side 296. The electrolyte 300 may pass the oxygen ions from the cathode side 296 to the anode side 298, and may have little or no electrical conductivity, so as to prevent passage of the free electrons from the cathode side 296 to the anode side 298.

The anode side of a solid oxide fuel cell (such as the fuel cell stack 294) may be composed of a nickel/yttria-stabilized zirconia (Ni/YSZ) cermet. Nickel in the anode side serves as a catalyst for fuel oxidation and current conductor. During normal operation of the fuel cell stack 294, the operating temperature may be greater than or equal to about 700° C., and the nickel (Ni) in the anode remains in its reduced form due to the continuous supply of primarily hydrogen fuel gas.

The fuel cell stack 294 is disposed downstream of the LP compressor 110, the HP compressor 112, or both. Further, as will be appreciated from the description above with respect to FIG. 2, the fuel cell stack 294 may be coupled to or otherwise integrated with a liner of the combustor 206 (e.g., an inner liner 208 or an outer liner 210). In such a manner, the fuel cell stack 294 may also be arranged upstream of the combustion chamber 228 of the integrated fuel cell and combustor assembly 200, and further upstream of the HP turbine 116 and LP turbine 118.

As shown in FIG. 5, the fuel cell assembly 204 also includes a fuel processing unit 304 and an air processing unit 306. The fuel processing unit 304 may be any suitable structure for generating a hydrogen rich fuel stream. For example, the fuel processing unit 304 may include a fuel reformer or a catalytic partial oxidation convertor (CPOx) for developing the hydrogen rich fuel stream for the fuel cell stack 294. The air processing unit 306 may be any suitable structure for raising the temperature of air that is provided thereto to a temperature high enough to enable fuel cell temperature control (e.g., about 600° C. to about 800° C.). For example, in the embodiment depicted, the air processing unit includes a preburner system, operating based on a fuel flow through the second fuel delivery line 150B, configured for raising the temperature of the air through combustion, e.g., during transient conditions such as startup, shutdown and abnormal situations.

In the exemplary embodiment depicted, the fuel processing unit 304 and air processing unit 306 are manifolded together within a housing 308 to provide conditioned air and fuel to the fuel cell stack 294.

It should be appreciated, however, that the fuel processing unit 304 may additionally or alternatively include any suitable type of fuel reformer, such as an autothermal reformer and steam reformer that may need an additional stream of steam inlet with higher hydrogen composition at the reformer outlet stream. Additionally, or alternatively, still, the fuel processing unit 304 may include a reformer integrated with the fuel cell stack 294. Similarly, it should be appreciated that the air processing unit 306 of FIG. 5 could alternatively be a heat exchanger or another device for raising the temperature of the air provided thereto to a temperature high enough to enable fuel cell temperature control (e.g., about 600° C. to about 800° C.).

As mentioned above, the compressor bleed system (and air stream supply duct 288) is in airflow communication with airflow delivery system for providing compressed airflow to the fuel cell assembly 204. The airflow delivery system includes an anode airflow duct 310 and an associated anode airflow valve 312 for providing an airflow to the fuel processing unit 304, a cathode airflow duct 314 and associated cathode airflow valve 316 for providing an airflow to the air processing unit 306, and a cathode bypass air duct 318 and an associated cathode bypass air valve 320 for providing an airflow directly to the fuel cell stack 294 (or rather to the cathode side 296 of the fuel cell(s)). The fuel delivery system 146 is configured to provide the first flow of fuel through the first fuel delivery line 150A to the fuel processing unit 304, and the second flow of fuel through the second fuel delivery line 150B to the air processing unit 306 (e.g., as fuel for a preburner system, if provided).

The fuel cell stack 294 outputs the power produced as a fuel cell power output 322. Further, the fuel cell stack 294 directs a cathode air discharge and an anode fuel discharge (neither labeled for clarity purposes) into the combustion chamber 228 of the combustor 206.

In operation, the air processing unit 306 is configured to heat/cool a portion of the compressed air, incoming through the cathode airflow duct 314, to generate a processed air to be directed into the fuel cell stack 294 to facilitate the functioning of the fuel cell stack 294. The air processing unit 306 receives the second flow of fuel from the second fuel delivery line 150B and may, e.g., combust such second flow of fuel to heat the air received to a desired temperature (e.g., about 600° C. to about 800° C.) to facilitate the functioning of the fuel cell stack 294. The air processed by the air processing unit 306 is directed into the fuel cell stack 294. In an embodiment of the disclosure, as is depicted, the cathode bypass air duct 318 and the air processed by the air processing unit 306 may combine into a combined air stream to be fed into a cathode 296 of the fuel cell stack 294.

Further, as shown in the embodiment of FIG. 5, the first flow of fuel through the first fuel delivery line 150A is directed to the fuel processing unit 304 for developing a hydrogen rich fuel stream (e.g., optimizing a hydrogen content of a fuel stream), to also be fed into the fuel cell stack 294. As will be appreciated, and as discussed below, the flow of air (processed air and bypass air) to the fuel cell stack 294 (e.g., the cathode side 296) and fuel from the fuel processing unit 304 to the fuel cell stack 294 (e.g., the anode side 298) may facilitate electrical power generation.

Because the inlet air for the fuel cell stack 294 may come solely from the upstream compressor section without any other separately controlled air source, it will be appreciated that the inlet air for the fuel cell stack 294 discharged from the compressor section is subject to the air temperature changes that occur at different flight stages. By way of illustrative example only, the air within a particular location in the compressor section of the gas turbine engine 100 may work at 200° C. during idle, 600° C. during take-off, 268° C. during cruise, etc. This type of temperature change to the inlet air directed to the fuel cell stack 294 may lead to significant thermal transient issues (or even thermal shock) to the ceramic materials of the fuel cell stack 294, which could range from cracking to failure.

Thus, by fluidly connecting the air processing unit 306 between the compressor section and the fuel cell stack 294, the air processing unit 306 may serve as a control device or system to maintain the air processed by the air processing unit 306 and directed into the fuel cell stack 294 within a desired operating temperature range (e.g., plus or minus 100° C., or preferably plus or minus 50° C., or plus or minus 20° C.). In operation, the temperature of the air that is provided to the fuel cell stack 294 can be controlled (relative to a temperature of the air discharged from the compressor section) by controlling the flow of fuel to the air processing unit 306. By increasing a fuel flow to the air processing unit 306, a temperature of the airflow to the fuel cell stack 294 may be increased. By decreasing the fuel flow to the air processing unit 306, a temperature of the airflow to the fuel cell stack 294 may be decreased. Optionally, no fuel can be delivered to the air processing unit 306 to prevent the air processing unit 306 from increasing and/or decreasing the temperature of the air that is discharged from the compressor section and directed into the air processing unit 306.

Moreover, as is depicted in phantom, the fuel cell assembly 204 further includes an airflow bypass duct 321 extending around the fuel cell 294 to allow a portion or all of an airflow conditioned by the air processing unit 306 (and combined with any bypass air through duct 318) to bypass the cathode side 296 of the fuel cell 294 and go directly to the combustion chamber 228. The airflow bypass duct 321 may be in thermal communication with the fuel cell 294. The fuel cell assembly further includes a fuel bypass duct 323 extending around the fuel cell 294 to allow a portion or all of a reformed fuel from the fuel processing unit 304 to bypass the anode side 298 of the fuel cell 294 and go directly to the combustion chamber 228.

As briefly mentioned above, the fuel cell stack 294 converts the anode fuel stream from the fuel processing unit 304 and air processed by the air processing unit 306 sent into the fuel cell stack 294 into electrical energy, the fuel cell power output 322, in the form of DC current. This fuel cell power output 322 is directed to a power convertor 324 in order to change the DC current into DC current or AC current that can be effectively utilized by one or more subsystems. In particular, for the embodiment depicted, the electrical power is provided from the power converter to an electric bus 326. The electric bus 326 may be an electric bus dedicated to the gas turbine engine 100, an electric bus of an aircraft incorporating the gas turbine engine 100, or a combination thereof. The electric bus 326 is in electric communication with one or more additional electrical devices 328, which may be adapted to draw an electric current from, or apply an electrical load to, the fuel cell stack 294. The one or more additional electrical devices 328 may be a power source, a power sink, or both. For example, the additional electrical devices 328 may be a power storage device (such as one or more batteries), an electric machine (an electric generator, an electric motor, or both), an electric propulsion device, etc. For example, the one or more additional electric devices 328 may include the starter motor/generator of the gas turbine engine 100.

Referring still to FIG. 5, the gas turbine engine 100 further includes a sensor 330. In the embodiment shown, the sensor 330 is configured to sense data indicative of a flame within the combustion section 114 of the gas turbine engine 100. The sensor 330 may be, for example, a temperature sensor configured to sense data indicative of an exit temperature of the combustion section 114, an inlet temperature of the turbine section, an exhaust gas temperature, or a combination thereof. Additionally, or alternatively, the sensor 330 may be any other suitable sensor, or any suitable combination of sensors, configured to sense one or more gas turbine engine operating conditions or parameters, including data indicative of a flame within the combustion section 114 of the gas turbine engine 100.

Moreover, as is further depicted schematically in FIG. 5, the propulsion system, an aircraft including the propulsion system, or both, includes a controller 240. For example, the controller 240 may be a standalone controller, a gas turbine engine controller (e.g., a full authority digital engine control, or FADEC, controller), an aircraft controller, supervisory controller for a propulsion system, a combination thereof, etc.

The controller 240 is operably connected to the various sensors, valves, etc. within at least one of the gas turbine engine 100 and the fuel delivery system 146. More specifically, for the exemplary aspect depicted, the controller 240 is operably connected to the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302. As will be appreciated from the description below, the controller 240 may be in wired or wireless communication with these components. In this manner, the controller 240 may receive data from a variety of inputs (including the gas turbine engine sensor 330 and the fuel cell sensor 302), may make control decisions, and may provide data (e.g., instructions) to a variety of output (including the valves of the compressor bleed system to control an airflow bleed from the compressor section, the airflow delivery system to direct the airflow bled from the compressor section, and the fuel delivery system 146 to direct the fuel flow within the gas turbine engine 100).

Referring particularly to the operation of the controller 240, in at least certain embodiments, the controller 240 can include one or more computing device(s) 332. The computing device(s) 332 can include one or more processor(s) 332A and one or more memory device(s) 332B. The one or more processor(s) 332A can include any suitable processing device, such as a microprocessor, microcontroller, integrated circuit, logic device, and/or other suitable processing device. The one or more memory device(s) 332B can include one or more computer-readable media, including, but not limited to, non-transitory computer-readable media, RAM, ROM, hard drives, flash drives, and/or other memory devices.

The one or more memory device(s) 332B can store information accessible by the one or more processor(s) 332A, including computer-readable instructions 332C that can be executed by the one or more processor(s) 332A. The instructions 332C can be any set of instructions that when executed by the one or more processor(s) 332A, cause the one or more processor(s) 332A to perform operations. In some embodiments, the instructions 332C can be executed by the one or more processor(s) 332A to cause the one or more processor(s) 332A to perform operations, such as any of the operations and functions for which the controller 240 and/or the computing device(s) 332 are configured, the operations for operating a propulsion system (e.g., method 600), as described herein, and/or any other operations or functions of the one or more computing device(s) 332. The instructions 332C can be software written in any suitable programming language or can be implemented in hardware.

Additionally, and/or alternatively, the instructions 332C can be executed in logically and/or virtually separate threads on processor(s) 332A. The memory device(s) 332B can further store data 332D that can be accessed by the processor(s) 332A. For example, the data 332D can include data indicative of power flows, data indicative of gas turbine engine 100/aircraft operating conditions, and/or any other data and/or information described herein.

The computing device(s) 332 also includes a network interface 332E configured to communicate, for example, with the other components of the gas turbine engine 100 (such as the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302), the aircraft incorporating the gas turbine engine 100, etc. The network interface 332E can include any suitable components for interfacing with one or more network(s), including for example, transmitters, receivers, ports, controllers, antennas, and/or other suitable components. In such a manner, it will be appreciated that the network interface 332E may utilize any suitable combination of wired and wireless communications network(s).

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated that the gas turbine engine 100, the exemplary fuel delivery system 146, the exemplary integrated fuel cell and combustor assembly 200, and the exemplary fuel cell assembly 204 are provided by way of example only. In other embodiments, the integrated fuel cell and combustor assembly 200 and fuel cell assembly 204 may have any other suitable configuration. For example, in other exemplary embodiments, the fuel cell assembly 204 may include any other suitable fuel processing unit 304. Additionally, or alternatively, the fuel cell assembly 204 may not require a fuel processing unit 304, e.g., when the combustor of the gas turbine engine 100 is configured to burn hydrogen fuel and the fuel delivery assembly 146 is configured to provide hydrogen fuel to the integrated fuel cell and combustor assembly 200, and in particular to the fuel cell assembly 204.

As briefly mentioned above, the fuel cell assembly 204 may be in electrical communication with the electric bus 326, which may be an electric bus of the gas turbine engine 100, of an aircraft, or a combination thereof. Referring now briefly to FIG. 6, a schematic view is provided of an aircraft 400 in accordance with an embodiment of the present disclosure including one or more gas turbine engines 100 (labeled 100A and 100B), each with an integrated fuel cell and combustor assembly 200 (labeled 200A and 200B), and an aircraft electric bus 326 in electrical communication with the one or more gas turbine engines 100.

In particular, for the exemplary embodiment depicted, the aircraft 400 is provided including a fuselage 402, an empennage 404, a first wing 406, a second wing 408, and a propulsion system. The propulsion system generally includes a first gas turbine engine 100A coupled to, or integrated with, the first wing 406 and a second gas turbine engine 100B coupled to, or integrated with, the second wing 408. It will be appreciated, however, that in other embodiments, any other suitable number and or configuration of gas turbine engines 100 may be provided (e.g., fuselage-mounted, empennage-mounted, etc.).

The first gas turbine engine 100A generally includes a first integrated fuel cell and combustor assembly 200A and a first electric machine 410A. The first integrated fuel cell and combustor assembly 200A may generally include a first fuel cell assembly. The first electric machine 410A may be an embedded electric machine, an offset electric machine (e.g., rotatable with the gas turbine engine 100 through an accessory gearbox or suitable geartrain), etc. For example, in certain exemplary embodiments, the first electric machine 410A may be a starter motor/generator for the first gas turbine engine 100A.

Similarly, the second gas turbine engine 100B generally includes a second integrated fuel cell and combustor assembly 200B and a second electric machine 410B. The second integrated fuel cell and combustor assembly 200B may generally include a second fuel cell assembly. The second electric machine 410B may also be an embedded electric machine, an offset electric machine (e.g., rotatable with the gas turbine engine 100 through an accessory gearbox or suitable geartrain), etc. For example, in certain exemplary embodiments, the second electric machine 410B may be a starter motor/generator for the second gas turbine engine 100B.

In the embodiment of FIG. 6, the aircraft 400 additionally includes the electric bus 326 and a supervisory controller 412. Further, it will be appreciated that the aircraft 400 and/or propulsion system includes one or more electric devices 414 and an electric energy storage unit 416, each in electric communication with the electric bus 326. The electric devices 414 may represent one or more aircraft power loads (e.g., avionics systems, control systems, electric propulsors, etc.), one or more electric power sources (e.g., an auxiliary power unit), etc. The electric energy storage unit 416 may be, e.g., a battery pack or the like for storing electric power.

The electric bus 326 further electrically connects to the first electric machine 410A and first fuel cell assembly, as well as to the second electric machine 410B and second fuel cell assembly. The supervisory controller 412 may be configured in a similar manner as the controller 240 of FIG. 5 or may be in operative communication with a first gas turbine engine controller dedicated to the first gas turbine engine 100A and a second gas turbine engine controller dedicated to the second gas turbine engine 100B.

In such a manner, it will be appreciated that the supervisory controller 412 may be configured to receive data from a gas turbine engine sensor 330A of the first gas turbine engine 100A and from a gas turbine engine sensor 330B of the second gas turbine engine 100B, and may further be configured to send data (e.g., commands) to various control elements (such as valves) of the first and second gas turbine engines 100A, 100B.

Moreover, it will be appreciated that for the embodiment depicted, the aircraft 400 includes one or more aircraft sensor(s) 418 configured to sense data indicative of various flight operations of the aircraft 400, including, e.g., altitude, ambient temperature, ambient pressure, airflow speed, etc. The supervisory controller 412 is operably connected to these aircraft sensor(s) 418 to receive data from such aircraft sensor(s) 418.

In addition to receiving data from sensors 330A, 330B, 418 and sending data to control elements, the supervisory controller 412 is configured to control a flow of electric power through the electric bus 326. For example, the supervisory controller 412 may be configured to command and receive a desired power extraction from one or more of the electric machines (e.g., the first electric machine 410A and second electric machine 410B), one or more of the fuel cell assemblies (e.g., the first fuel cell assembly and second fuel cell assembly), or both, and provide all or a portion of the extracted electric power to other of the one or more of the electric machines (e.g., the first electric machine 410A and second electric machine 410B), one or more of the fuel cell assemblies (e.g., the first fuel cell assembly and second fuel cell assembly), or both. One or more of these actions may be taken in accordance with the logic outlined below.

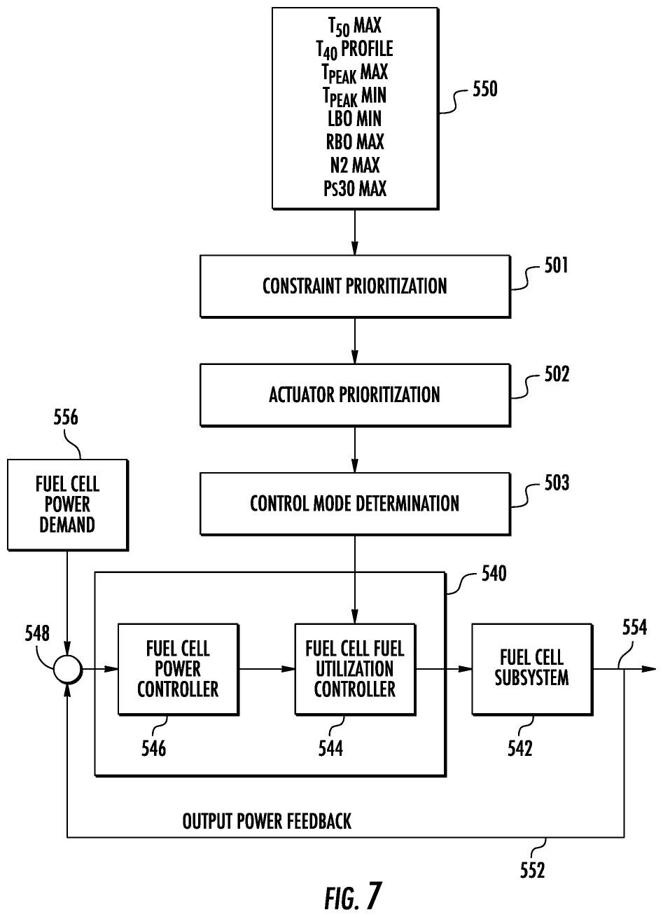

As will be appreciated, one or more of the exemplary gas turbine engines 100 described herein may be configured to monitor and control various aspects of engine status. For example, a gas turbine engine as described with reference to FIG. 5 may use its controller 240 to monitor and control one or more engine constraints. Referring now to FIG. 7, a flow diagram depicts an exemplary embodiment of a control system configured to monitor and control one or more engine constraints in a propulsion system. It should be appreciated that this control system may be combined or integrated with other embodiments as described herein, for example the embodiment of FIG. 5 and its controller 240.

Still referring to FIG. 7, a fuel cell controller 540 may be provided to control inputs and outputs of a fuel cell subsystem 542 (e.g., the hardware of a fuel cell assembly). In one or more embodiments, the fuel cell controller 540 may be configured to control a fuel cell power output 554 of the fuel cell subsystem 542. Controlling the fuel cell power output 554 can be used to tune the amount of energy supplied to other components of an aircraft, such as the electric device(s) 328 described with reference to FIG. 5 or the electric machines 410A, 410B described with reference to FIG. 6. Additionally or alternatively, the fuel cell controller 540 may be configured to control the fuel cell power output 554 to in turn control one or more aspects of the gas turbine engine 100 beyond the fuel cell subsystem 542.

A fuel cell power controller 546 may receive a fuel cell power demand 556 from the aircraft control system or external input such as from a pilot. A control error or difference between the fuel cell power demand 556 and a fuel cell power output feedback 552 can be determined in a block 548. A calculation in block 548 may be an arithmetic difference calculation with or without filtering on data from the fuel cell power demand 556 and the fuel cell output power feedback 552. Multiple operating parameters inside the fuel cell subsystem 542 may be referred to as “control knobs” used to control the fuel cell power output 554. Available control knobs may include fuel cell current, fuel cell voltage, fuel cell fuel flowrate, fuel cell air flowrate, fuel cell temperature, fuel cell fuel utilization, etc.

A fuel cell control system 540 as depicted in FIG. 7 may include a plurality of control modes, for example: a power tracking mode and a maximum fuel efficiency mode. A description of possible control modes is provided in U.S. patent application Ser. No. 17/322,507, which is incorporated herein by reference in its entirety. In an exemplary power tracking mode, the fuel cell power controller 546 may adjust the fuel cell subsystem 542 to track the fuel cell power demand 556. For example, the fuel cell power demand 556 may be operable to request a maximum power output, wherein the fuel cell controller 540 may correspondingly adjust the fuel cell subsystem 542 to achieve its maximum allowed power output based on one or more constraints to fuel cell operation. In an exemplary maximum fuel efficiency mode, the fuel cell controller 540 may adjust the fuel cell subsystem 542 to achieve a maximum fuel efficiency, for example by operating the fuel cell subsystem 542 at higher voltage and/or by adjusting fuel utilization. In the exemplary maximum fuel efficiency mode, the fuel cell subsystem 542 may still be able to track the fuel cell power demand 556 with the fuel cell power output 554, but may also allow the fuel cell power output 554 to deviate from the fuel cell power demand 556 to achieve a desired fuel efficiency.

The gas turbine engine 100 may monitor various aspects during operation to ensure efficiency and performance. For example, one or more controllers, such as a FADEC as described above with reference to FIG. 5, may monitor temperatures, speeds, and other variables relevant to engine performance. Some of the monitored variables may include a core shaft speed (N2), a fan shaft speed (N1), exit temperature of the LP turbine 118 (T₅₀), inlet temperature of the high pressure turbine 116 (T₄₀), a hot gas path (HGP) temperature, air fuel ratio (for example indicative of lean blowout (LBO) or rich blowout (RBO)), minimum peak temperature, maximum peak temperature, and/or a discharge static pressure of the HP compressor 112 (Ps30). As used herein, some or all of these monitored variables may be referred to as one or more engine constraints 550. It should be appreciated that this list of variables is not exhaustive and any number or type of different variables could be used as engine constraints 550. The engine constraint(s) 550 may be detected by various sensors, for example any of the sensors 330, 330A, 330B, 418 described above with reference to FIGS. 5 and 6, and may also be computed, for example by a calculation based on one or more inputs from one or more sensors. In an embodiment, a ratio unit (RU) may be calculated indicative of a fuel flow rate (Wf) divided by compressor discharge static pressure. It should also be appreciated that the engine constraint(s) 550 may be indicative of non-measured aspects of engine performance. For example, acceleration of shaft speeds (N1) and (N2) may serve as a proxy for stall margin.

As depicted in FIG. 7, monitoring of the engine constraints 550 can lead to actions taken by the fuel cell controller 540. For example, if a given one of the engine constraints 550 has a measured value identified as negatively impacting engine performance, efficiency, or longevity, then the fuel cell controller 540 may control one or more aspects of the fuel cell subsystem or inputs to the fuel cell subsystem to affect a value of the engine to improve engine performance, efficiency, or longevity (a corrective action, or more particularly a fuel cell corrective action). For example, the fuel cell controller 540 may be configured to perform the corrective action responsive to one or more engine constraints 550. In the embodiment shown, measurements of the one or more engine constraints 550 are processed by one or more controllers to determine if corrective action should be taken, and if so, how such corrective action should be performed. This new fuel cell operating mode may be referred to as a versatility mode, with the fuel cell providing versatile function to enhance the engine operability.

In certain exemplary aspects, the fuel cell corrective action may include one or more of a modification of the air processing unit (e.g., increasing or decreasing a fuel flow to a burner, affecting a temperature of the airflow to the fuel cell and of the output products); the fuel processing unit (affecting an amount of fuel provided to the fuel cell, and thus a composition of the output products); a location of compressed air provided to the fuel cell (affecting a temperature and pressure of such air); a power extraction of the fuel cell (affecting a completeness of the chemical reaction within the fuel cell and thus a composition of the output products, as well as potentially affect an amount of power that must be extracted from outer power sources, such as one or more electric machines driven by the turbomachine, other fuel cell assemblies, etc.); a bypass around the air processing unit, etc.

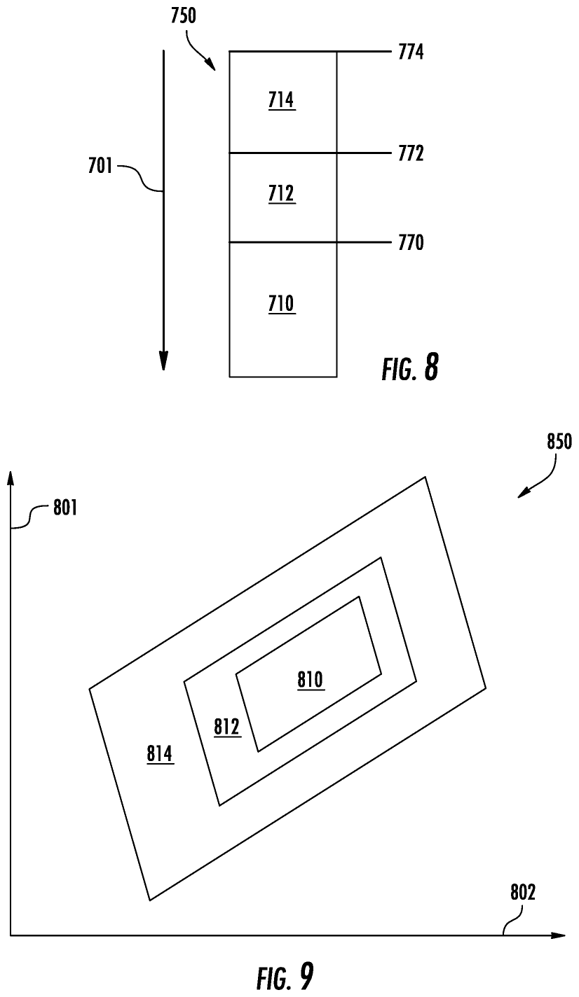

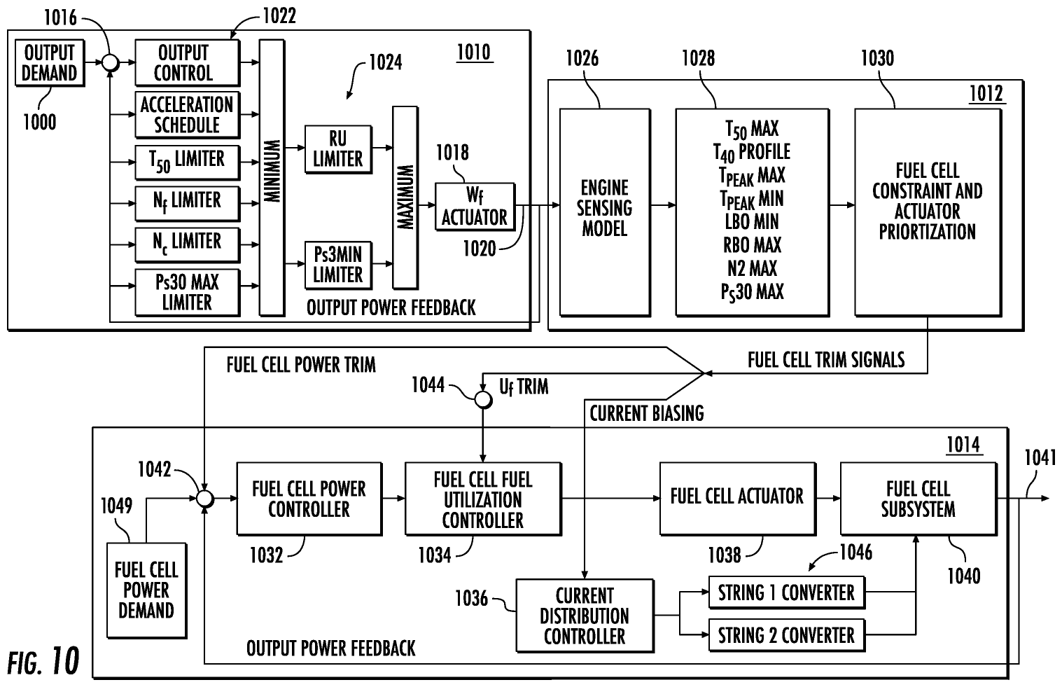

One or more controllers may be configured to receive data indicative of the engine constraint(s) 550. For example, the fuel cell controller 540 may receive this data, or another controller or other controllers, for example as described with reference to FIGS. 5 and 6, may be configured to receive this data. Based on the received data, the controller(s) may be configured to determine if the engine constraint 550 has achieved one or more thresholds. Such a threshold may be achieved, for example, by exceeding or falling below a programmed value. In various embodiments, a variety of thresholds may be set to indicate allowable or desirable operability ranges as described in more detail with reference to FIGS. 8 and 9 below.

Data indicative of the engine constraint(s) 550 may be acted upon by a controller, for example the fuel cell controller 540, based on one or more determinations or prioritization events. In the embodiment depicted in FIG. 7, a constraint prioritization 501, an actuator prioritization 502, and a control mode determination 503 may be performed, wherein the fuel cell controller 540 is configured to act responsive to these determinations and prioritizations.

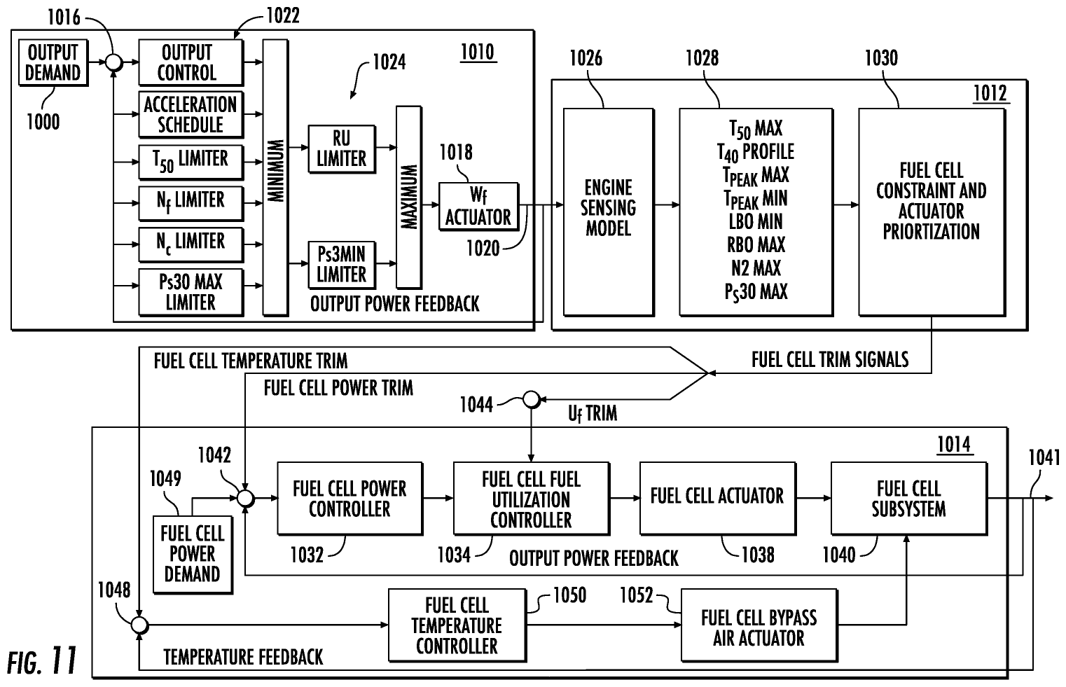

The constraint prioritization 501 may be configured to determine a priority sequence of addressing engine constraints 550 by action of the fuel cell controller 540. For example, engine constraints 550 may be addressed in an order set based at least in part on a magnitude of deviation from an operability limit as described in greater detail with reference to FIGS. 10-13. It should be understood that such a priority sequence may be set based on other variables to account for objectives related to fuel efficiency, engine longevity, stall margin, etc.

The actuator prioritization 502 may be configured to determine a priority sequence of actuators used to address the engine constraint(s) 550. For example, the priority sequence of the actuator prioritization 502 may be based at least in part on operating margins of a plurality of actuators available to perform a corrective action.

As described above, one or more fuel cell control modes may include a power tracking mode, a maximum fuel efficiency mode, and a versatility mode as introduced herein. The power tracking mode may be used to prioritize accurately outputting a power demand and the versatility mode may be used to prioritize engine operability constraints. In various embodiments, default mode prioritization may be provided, wherein the power tracking mode may override the versatility mode, and wherein the versatility mode may override the maximum fuel efficiency mode. For example, when maximum power or versatility is not requested, the control mode determination 503 in FIG. 7 may select the maximum fuel efficiency mode as a default mode. The control mode determination 503 may be configured to determine when the versatility mode will be enabled or whether one or more actuators should be used to perform a corrective action to alleviate the engine constraint prioritized in block 501. For example, the control mode determination 503 may include a user input or computer determination of a current control mode. One example of a computer-determined control mode, based on the setting of an engine constraint limit, is described in greater detail with reference to FIG. 8 below.

In the versatility mode, the system can benefit from using various actuators, such as fuel cell actuators of the fuel cell subsystem 542 to enhance the engine operability by moving the engine constraints 550 away from respective or combined operability limits. In the embodiment shown in FIG. 7, a fuel cell fuel utilization controller 544 and a fuel cell power controller 546 are provided to regulate the fuel cell subsystem 542. These controllers 544, 546 may be integrated into the fuel cell controller 540 or may be provided separately. Adjusting actuators of the fuel cell subsystem 542, can serve to perform corrective action to address the engine constraint(s) 550. For example, increasing fuel utilization with the fuel cell fuel utilization controller 544 can be used to decrease an engine temperature. In an embodiment, a system such as the integrated fuel cell and combustor assembly 200 described with reference to FIGS. 2 and 3 may adjust an amount or composition of output products provided by the fuel cell subsystem 542, in turn adjusting a temperature within the combustor assembly 200 or exiting the combustor assembly 200/entering a turbine section. It should be appreciated that, based on the system enthalpy, controlling the electrical output from the fuel cell subsystem can be used to control various engine constraints 550 by increasing or decreasing energy drawn from the system (affecting a composition of the output products).

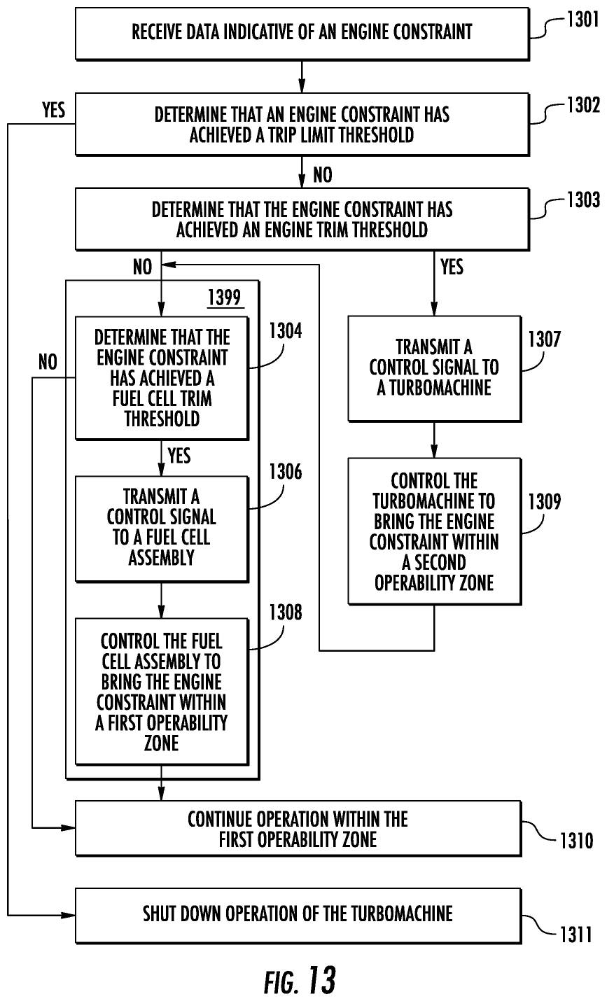

The fuel cell subsystem 542 may operate based on one or more power setpoints and feedback control, for example as described above with reference to FIG. 2. Still referring to the embodiment of FIG. 7, a fuel cell setpoint 548 is schematically depicted. The fuel cell setpoint 548 is shown as controlled at least in part through a fuel cell feedback signal 552 and the fuel cell power demand 556. For example, the fuel cell feedback signal 552 may provide a direct or indirect measurement of an actual power output 554 of the fuel cell subsystem 542 so that the fuel cell setpoint 548 may be adjusted to account for variables causing actual power output 554 to differ from requested fuel cell power demand 556. Thus, it should be appreciated that the fuel cell fuel utilization controller 544 may be adjusted responsive to the engine constraint(s) 550 as described above without necessarily changing actual power output 554 of the fuel cell subsystem 542 (e.g., the fuel cell fuel utilization controller 544 may make an adjustment to vary a composition of the output products provided to the combustion section, and the feedback signal 552 may allow for adjustments to be made to maintain the actual power output 554 at a desired level). However, it should also be appreciated that the actual power output 554 may also be controlled as a potential actuator to perform corrective actions responsive to the engine constraint(s), as will be described in greater detail below with reference to FIG. 12.

Referring now to FIG. 8, a graphical representation of an exemplary engine constraint 750 is provided. For example, the engine constraint 750 represent a speed, temperature, or other variable as described above with reference to FIG. 7. An engine operability indicator 701 may be used to measure the engine constraint 750, where the engine operability indicator 701 increases in the direction of the arrow depicted. the operability margin is defined as the “difference between the current measurement to a given operability threshold such as 770 or 772 or 774”. As used herein, a greater operability margin corresponds to improved engine operability, which may be measured in fuel utilization, emission performance, or various other metrics. For example, the engine operability indicator 701 may be a temperature value representative of a temperature, such as T₅₀ or T₄₀ as described above with reference to FIG. 7. In this example, as the temperature value gets closer to a trim or trip limit, a respective operability margin is reduced. As the operability margin reaches zero, it is said that the respective threshold has been achieved and a corresponding trim or trip action is provided. Accordingly, a bounded operability window may be defined, as described in greater detail with reference to FIG. 9.

Various operability zones may be defined for a given engine constraint 750. These operability zones, as well as corresponding limits are used to facilitate the control mode determination 503. As depicted in FIG. 8, a first operability zone 710, a second operability zone 712, and a third operability zone 714, are provided. Each of these operability zones 710, 712, 714 may correspond to a specific operability range indicative of various performance variables as described above. The respective limits 770, 772, 774 define an engine operability limit which may trigger one or more control actions. The engine operability indicator 701 may refer to whether or not the engine parameter has reached its limit, beyond which may lead to the physical failure such as mechanical damage, fan blade out, and/or operational life reduction, etc. For example, from top to bottom, a trip limit threshold 774 may represent an engine operability limit, beyond which combustor shut down is required, shutting off combustor fuel to at least a portion of the combustor. Using high pressure turbine inlet temperature, or T₄₀, as an example, the trip limit threshold 774 may be 1500° C. An engine trim threshold 772 may be provided prior to the trip limit threshold 774, where the engine trim threshold 772 represents an engine operability limit that exceeding may require trimming one or more engine constraints, such as a combustor fuel flowrate to reduce combustor and engine thrust output, in turn reducing temperature. Using a low pressure turbine outlet temperature, or T₅₀, as an example, the engine trim threshold 772 may be 1400° C.

A fuel cell trim threshold 770 may also be provided as described herein. The fuel cell trim threshold 770 may represent an engine operability limit that exceeding may trigger trimming one or more fuel cell parameters. Using the T₅₀ example as above, the fuel cell trim threshold may be 1300° C. In this example, if it is determined that this T₅₀ value exceeds the fuel cell trim threshold 770, then the control mode determination 503 may automatically trigger the fuel cell versatility mode. Accordingly, the introduction of the fuel cell trim threshold 770 facilitates preventive action with the fuel cell as at least one actuator to alleviate engine operability constraints, potentially avoiding achieving the engine trim threshold 772 and/or the trip limit threshold 774 and their respective actions of adjusting engine constraints and potentially shutting down operation. This threshold operation may increase the availability and reliability of the engine thrust service by using a fuel cell.

As above, the first operability zone 710 may correspond to a preferred operability range where no corrective action is necessary. The first operability zone 710 may be bounded by at least one threshold, for example the fuel cell trim threshold 770. When operating within the first operability zone 710, the engine constraint 750, for example a temperature as described above, is said to be operating without achieving the fuel cell trim threshold 770. Once the engine constraint 750 defines an engine operability indicator 701 outside of the first operability zone 710, the engine constraint is said to have achieved the fuel cell trim threshold 770. The fuel cell trim threshold 770 may be representative of departure from a desired value or range as described further below. For example, the fuel cell trim threshold 770 may represent values relating to a fuel inefficiency of an engine, an engine operability indicator, or an engine life indicator. The engine fuel inefficiency may refer to an inefficiency of the combustor in combusting aviation fuel. The engine operability indicator may refer to whether or not the combustion section is generating enough power for the engine to achieve a desired thrust or other power indicator. The engine life indicator may refer to a variety of parameters indicating whether or not the engine is operating in a manner that is likely to cause the engine to degrade more quickly than desired (e.g., higher temperatures, pressures, pressure fluctuations, etc.).

Once the engine constraint 750 has achieved the fuel cell trim threshold 770, the engine operability indicator 701 next moves to the second operability zone 712, bounded between the fuel cell trim threshold 770 and the engine trim threshold 772. The engine trim threshold 772 may, for example, be indicative of a maximum predicted change in the engine constraint 750 possible with a maximum capability of a fuel cell, or some lesser predicted change in the engine constraint 750 that may be achieved by modifying the fuel cell operation without substantially detrimentally affecting fuel cell operations, operability, or lifespan. This second operability zone 712 may be representative of a corrective range of a fuel cell assembly, for example the fuel cell subsystem 542 described with reference to FIG. 7. Thus, when the engine constraint 750 has achieved the fuel cell trim threshold 770, but has not achieved the engine trim threshold 772, a fuel cell assembly such as the fuel cell subsystem 542 may be configured to perform a fuel cell corrective action. It should be understood that various controllers, for example the fuel cell controller 540 of FIG. 7, may be configured to make determinations as to which thresholds have been achieved and thus into which of the operability zones 710, 712, 714 the engine constraint falls.

Referring still to FIG. 8, beyond the engine trim threshold 772, the third operability zone 714 is bounded by the trip limit threshold 774. In an embodiment, the trip limit threshold 774 is the maximum allowable range of the engine constraint 750 prior to mandatory shut down. The third operability zone 714 may be representative of a zone beyond which control of a fuel cell assembly is insufficient to perform complete corrective action on the engine constraint 750. For example, one or more controllers may be configured to perform a turbomachine corrective action with a turbomachine (e.g. reducing a fuel supplied by one or more of the fuel flow valves 151A, B, C, as described with reference to FIG. 5, actuating one or more variable geometry components of the turbomachine, etc.). In this embodiment, it should be understood that turbomachine corrective action and fuel cell corrective action (collectively referred to as “corrective actions”) may be performed in concert. For example, the fuel cell corrective action performed with the fuel cell controller 540 responsive to the engine constraint 750 achieving the fuel cell trim threshold 770 may be augmented by further turbomachine corrective action performed with one or more of the fuel flow valves 151A, B, C responsive to the engine constraint 750 achieving the engine trim threshold 772. Alternatively, certain embodiments may be configured such that only the turbomachine corrective action is performed under such conditions. In an embodiment, at least one controller is configured to adjust an inlet guide vane assembly or reduce a fuel supply to the turbomachine as the turbomachine corrective action when the engine constraint 750 has achieved the engine trim threshold 772.

As briefly described above, the third operability zone 714 is further bounded by the trip limit threshold 774. The trip limit threshold 774 may represent a maximum allowable value of the engine constraint 750. For example, the engine constraint 750 achieving the trip limit threshold 774 may present sufficient risk to an aircraft that one or more systems is required to trip, or shut down operation. Thus, during operation in the third operability zone 714, it may be a priority to bring the engine constraint 750 at least back within the second operability zone 712. In an embodiment, all available actuators, including fuel cell assembly and turbomachine actuators, may be employed to perform corrective action responsive to operation in the third operability zone 714.

Turning now to FIG. 9, it should be understood that one or more engine constraints may together define corrective action. This notion is based on interaction between engine constraints and between corrective actions. As depicted in FIG. 9, a first operability indicator 801 is provided on a Y-axis and a second operability indicator 802 is provided on an X-axis. A given engine constraint 850 may define an operability window along each of these axes. As depicted, the operability window along the X-axis may depend on a value along the Y-axis and vice versa.

In the exemplary embodiment of FIG. 9, a first operability zone 810, a second operability zone 812, and a third operability zone 814 are defined. It should be understood that the operability zones 810, 812, 814 may generally correspond to the operability zones 710, 712, 714 and the thresholds 770, 772, 774 defined therebetween with reference to FIG. 8. As described briefly with reference to FIG. 8, operability zones may extend beyond the first operability zone 710, 810 in both directions for a given engine constraint. Thus, the first operability zone 810 of FIG. 9 may represent a preferred operating range of the first and second operability indicators 801, 802, where the second and third, operability zones 812, 814 represent increasing departure from that preferred operating range. For example, the first operability indicator 801 may represent a temperature, such as T40 or T50 as described above, with the operability zones 810, 812, 814 defining operability windows and thresholds along the Y-axis and the second operability indicator 802 may represent an air to fuel ratio with the operability zones 810, 812, 814 defining operability windows and thresholds along the X-axis. It should be appreciated that although the first and second operability indicators are shown to influence one another, that is not necessarily the case as certain engine constraints 860 may operate independently.

Thresholds defined between the operability zones 810, 812, 814 in FIG. 9 may generally correspond to those described with reference to FIG. 8. For example, a fuel cell trim threshold may define the boundary between the first operability zone 810 and the second operability zone 812 and an engine trim threshold may define the boundary between the second operability zone 812 and the third operability zone 814. Also as described above, the first operability zone 810 may represent an ideal value, or in this case combination of values along the first operability indicator 801 and the second operability indicator 802. In this case, the first operability zone 810 may thus be a point on the graph of FIG. 9 defining an ideal value along the X- and Y-axes, beyond which corrective action may be taken. As above, corrective action may preferentially be performed with one or more fuel cell actuators, for example upon achieving the fuel cell trim threshold.

Turning now to FIG. 10, an exemplary embodiment of a propulsion system control model is depicted. As shown, one or more controllers may cooperate together to control operation of a propulsion system, and it should be appreciated that more or fewer controllers than depicted could be provided, for example by combination or separation of those controllers depicted. In particular, it will be appreciated that as used herein, the description of multiple controllers as part of the disclosed control model does not necessarily require separate controller structures or hardware, and instead the multiple controllers described herein may all be integrated into a single computing device, or any suitable number or arrangement of computing devices.

In the embodiment of FIG. 10, a turbomachine controller 1010, a priority controller 1012, and a fuel cell controller 1014 are provided. Beginning with the turbomachine controller 1010, actions may be performed responsive to an output demand 1000, which may for example be a thrust request from an operator as with a throttle lever. Responsive to the output demand 1000, a turbomachine setpoint 1016 is provided. Based on one or more engine constraints, a fuel consumption (Wf) actuator 1018 controls an amount of fuel supplied to the turbomachine, providing a corresponding turbomachine power 1020. As depicted, the turbomachine controller 1010 may use a feedback signal from the turbomachine power 1020 to adjust the turbomachine setpoint 1016 such that the turbomachine power 1020 actually output meets the output demand 1000 requested. It should be appreciated that output power, or thrust, is not necessarily measured. Instead, a proxy for actual output power, for example engine pressure ratio (EPR), may be employed for control purposes.

As above, various engine constraints may further determine, or constrain, operation of the turbomachine controller 1010. For example, one or more limiters or further controls may be provided to constrain ranges of operation for given engine constraints. In the embodiment depicted in FIG. 10, a plurality of first limiters 1022 and a plurality of second limiters 1024 cooperate to control operation of the turbomachine 1010, in what may be referred to as a minimum/maximum control process. For example, the turbomachine controller 1010 may be configured to compare values of a given engine constraint against minimum and/or maximum permitted values with one or more of the limiters 1022, 1024. As described in greater detail below, these limiters 1022, 1024 for use in the turbomachine controller 1010 may be tuned to account for adjustment capacity elsewhere. For example, adjustment capacity in fuel cell controller 1014 may facilitate a broader allowed range of the limiters 1022, 1024 of the turbomachine controller 1010 while maintaining adequate control of the one or more engine constraints.

A signal indicative of engine output, for example EPR as described in the above feedback control, may further be transmitted to at least one other controller. As depicted, an engine sensing model 1026 of the priority controller 1012 is configured to receive data indicative of the turbomachine power 1020. The engine sensing model 1026 may be configured to determine preferred values of one or more engine constraints 1028 given engine operation conditions and demands. For example, a complex multivariate analysis may be performed to determine preferred values or ranges for each of the engine constraints 1028 given power, flight plan, emissions, and efficiency requirements. Following such a determination, the priority controller 1012 may further be configured to determine a priority of corrective action with an action priority controller 1030. In such a manner, the priority controller 1012 may determine a priority sequence of the plurality of actuation controllers. The action priority controller 1030 may be configured to determine constraints of its actuators available for corrective action and to prioritize use of each available actuator based at least in part on this determination. As with the engine sensing model 1026, a complex multivariate analysis may be performed to determine preferred priority of actuators for corrective action based on further variables, also including power, flight plan, emissions, and efficiency requirements. However, it should also be appreciated that a default priority of actuators may also be provided.

In the embodiment depicted in FIG. 10, the fuel cell controller 1014 includes a variety of actuators available for corrective action. At least one output signal is transmitted from the priority controller 1012 to the fuel cell controller 1014 to command at least one corrective action. A plurality of actuation controllers may be configured to perform one or more corrective actions when one or more engine constraints 1028 have achieved the operability limit threshold as described above with reference to FIGS. 8 and 9. The fuel cell controller 1014 is configured to modify operation of a fuel cell when the engine constraint(s) 1028 has or have achieved the operability limit threshold but has not achieved the engine trim threshold as described with reference to FIGS. 8 and 9.

The fuel cell controller 1014 may contain further controllers to be used as independent actuators or may itself function as a plurality of controllers. For example, the embodiment of FIG. 10 depicts the fuel cell controller 1014 including a fuel cell power controller 1032, a fuel cell fuel utilization controller 1034, and a current distribution controller 1036.

The fuel cell power controller 1032 may be configured to modify operation of a fuel cell fuel actuator 1038 as a possible fuel cell corrective action, for example by increasing an electric output of a fuel cell subsystem 1040. The fuel cell fuel utilization controller 1034 may also control the fuel cell subsystem 1040 as a possible fuel cell corrective action, for example through the same fuel cell actuator 1038. The fuel cell fuel utilization controller 1034 may be used to control a utilization of, e.g., hydrogen fuel provided to the fuel cell subsystem, affecting a composition of output products provided by the fuel cell subsystem to a combustion chamber. In various embodiments, the fuel cell fuel utilization controller 1034 may be a preferred controller, for example prioritized by default by the priority controller 1012. At least one possible advantage of employing the fuel cell fuel utilization controller 1034 could be maintaining a desired fuel cell power output 1041.

As depicted in the embodiment of FIG. 10, the fuel cell power controller 1032 has a fuel cell power setpoint 1042 and the fuel cell fuel utilization controller 1034 has a fuel cell fuel utilization setpoint 1044. These setpoints 1042, 1044 may be used for feedback control as described above, for example maintaining given fuel cell power outputs and fuel utilization values. A fuel cell power demand 1049 may also be provided as an input to the fuel cell power setpoint 1042, for example to request the desired fuel cell power output 1041.

The current distribution controller 1036 may control a distribution of current across a fuel cell subsystem 1040, for example circumferentially around the embodiment depicted in FIG. 3. By controlling current distribution in at least two areas with one or more converters 1046, the fuel cell subsystem 1040 may account for the combustor local variances (e.g., in temperature, pressure, or both) without affecting total power outputs or fuel utilizations for the entire fuel cell subsystem 1040, the combustor (using aviation fuel), or both. Further explanation of such a system is provided in U.S. patent application Ser. No. 17/406,894, filed Aug. 19, 2021, which is incorporated by reference in its entirety.

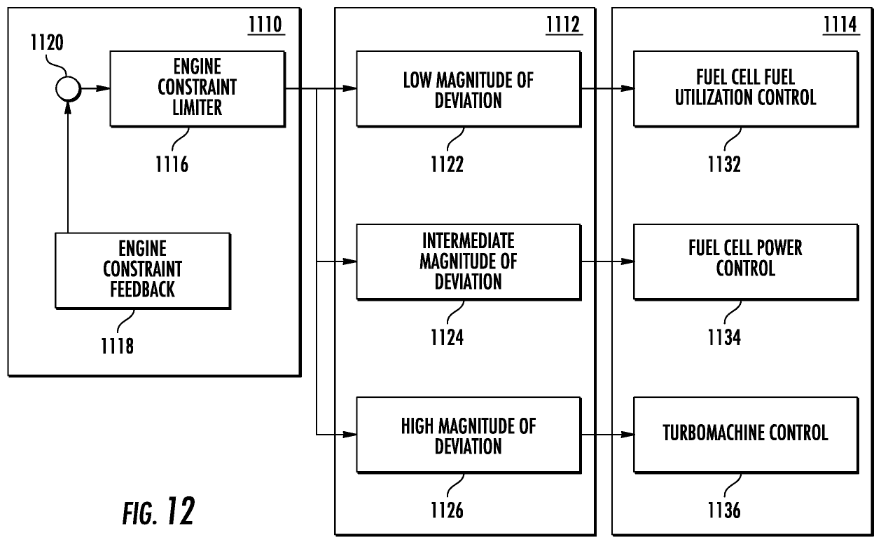

Referring now to FIG. 11, a system as in FIG. 10 may further include a fuel cell temperature controller 1050. Although the embodiment of FIG. 11 depicts the fuel cell temperature controller 1050 in place of the current distribution controller 1036 (see FIG. 10), it should be understood that these embodiments could also be combined. The fuel cell temperature controller 1050 is configured to regulate a temperature of the fuel cell subsystem 1040 responsive to one or more trim signals. For example, a fuel cell temperature trim signal may be communicated to set a fuel cell temperature setpoint 1048 to provide for corrective action responsive to one or more engine constraints 1028. The fuel cell temperature setpoint 1048 may be further regulated using feedback control as described above, for example with temperature data feedback from the fuel cell subsystem 1040.

To regulate temperature of the fuel cell subsystem 1040, the fuel cell temperature controller 1050 may operate the air processing unit, select a compressed air source, operate various cooling devices, or a combination thereof. For example, the fuel cell subsystem 1040 and fuel cell temperature controller 1040 may increase or decrease a fuel flow to the air processing unit (e.g., a burner), may extract compressed air from a location further upstream (cooler) or further downstream (hotter) within the compressor section of the engine, and/or may operate a fuel cell bypass air actuator 1052 to regulate the amount of cooling air flowing to the fuel cell subsystem 1040. In this way, the fuel cell temperature controller 1050 is configured to modify operation when the engine constraint(s) 1028 has or have achieved an operability limit threshold but has not achieved an engine trim threshold. Accordingly, temperature, and thus performance, of the fuel cell subsystem 1040 can be regulated with the fuel cell temperature controller 1050, providing yet another potential actuator capable of performing corrective action on a turbomachine using a fuel cell assembly.

Turning now to FIG. 12, another embodiment of a control system is provided. In this embodiment, a constraint controller 1110, a priority controller 1112, and an action controller 1114 are provided. However, it should be understood that these controllers 1110, 1112, 1114 are merely exemplary and could be combined or separated. In the depicted embodiment, the constraint controller 1110 includes an engine constraint limiter 1116, controlled by engine constraint feedback 1118 to maintain a constraint setpoint 1120. The constraint setpoint 1120 may be set to achieve various goals and may be variable. For example, the constraint setpoint 1120 may correspond to an ideal value or range in line with the first operability zones 710, 810 discussed with reference to FIGS. 8 and 9.

When the engine constraint limiter 1116 determines that the constraint setpoint 1120 is not met, the priority controller 1112 may sort deviations from the constraint setpoint 1120, for example based on a magnitude. In the embodiment of FIG. 12, the priority controller 1112 is configured to determine a priority sequence based on a magnitude of deviation of at least one engine constraint based on data from the constraint controller 1110. As shown, a low magnitude of deviation 1122, an intermediate magnitude of deviation 1124, and a high magnitude of deviation 1126 may represent various departures from the constraint setpoint 1120, corresponding generally with the engine trim threshold 772 described with reference to FIG. 8.

The priority controller 1112 may be configured to transmit at least one control signal responsive to its determined priority sequence. For example, the priority controller 1112 may transmit control signals to various fuel cell or turbomachine controllers as described above to perform corrective actions. As shown in FIG. 12, the corrective action performed, and the controller requested to perform such action, can be selected on the basis of the priority sequence. As shown, a determination of low magnitude of deviation 1122 may trigger a corrective action by modifying fuel cell fuel utilization control 1132, for example with the fuel cell fuel utilization controller 1034 described with reference to FIGS. 10 and 11. A determination of intermediate magnitude of deviation 1124 may trigger a corrective action by modifying fuel cell power control 1134, for example with the fuel cell fuel power controller 1032 described with reference to FIGS. 10 and 11. Finally, a determination of a high magnitude of deviation 1126 may trigger a corrective action by modifying turbomachine control 1136, for example with the fuel valves 151A, 151B, and/or 151C described with reference to FIG. 5.

Referring now to FIG. 13, a flow chart of a method of operating a propulsion system having a fuel cell and a turbomachine according to an embodiment is described. It will be appreciated that the order of steps disclosed with respect to the method of FIG. 13 is by way of example only. In other exemplary aspects, the order and arrangement of these steps may be varied.

According to the method, a first process 1301 of receiving data indicative of an engine constraint is performed. In a second process 1302, it is determined whether the engine constraint has achieved a trip limit threshold, for example the trip limit threshold 774 described with reference to FIG. 8. As in that embodiment, if the trip limit threshold has been achieved, the method may shut down operation of the turbomachine in a final process 1311 of the present method.

If the trip limit threshold has not been achieved, the method may proceed to a third process 1303 in which it is determined whether the engine constraint has achieved an engine trim threshold, such as the engine trim threshold 772 described with reference to FIG. 8. If the determination is made that the engine trim threshold has not been achieved, the method may proceed to a first versatility process 1304. If the engine trim threshold has been achieved, the method proceeds to a first alternative process 1307 as described further below.

Turning back to the first versatility process 1304, this represents a first process in a so-called engine versatility mode 1399. The engine versatility mode 1399 generally facilitates operation of a fuel cell assembly to perform corrective actions as described elsewhere herein. In this first versatility process 1304, a determination is made as to whether the engine constraint has achieved a fuel cell trim threshold, for example corresponding to the fuel cell trim threshold 770 described with reference to FIG. 8. If it is determined that the fuel cell trim threshold has not be achieved, that is to say that no corrective action is required, then the method may proceed to the fourth process 1310 and continue operation within a first operability zone, for example that described with reference to FIGS. 8 and 9. However, if it is determined that the engine constraint has achieved the fuel cell trim threshold, then the method proceeds to a second versatility process 1306.

In the second versatility process 1306 and the third versatility process 1308, corrective action may be performed with a fuel cell assembly. For example, the method may employ control of a fuel cell subsystem 1040 as described with reference to FIGS. 10 and 11 to perform corrective action. As shown, the method transmits a control signal to a fuel cell assembly (process 1306) which controls the fuel cell assembly to bring the engine constraint within the first operability zone (process 1308). Although not shown in this flow diagram, if for some reason control of the fuel cell assembly cannot effectively or efficiently bring the engine constraint within the operability limit threshold, the method may proceed to operation in the alternative mode described below.

In the first alternative process 1307 referenced briefly above, the method proceeds along similar lines as in the versatility mode 1399 to perform corrective action. However, in the first alternative process 1307 and the second alternative process 1309, a control signal is instead transmitted to the turbomachine (process 1307) to control the turbomachine to bring the engine constraint within at least a second operability zone, for example that described with reference to FIGS. 8 and 9 (process 1309). From that point, the method may proceed to the versatility mode, as operation in the second operability zone is indicative of a determination that the engine constraint has not achieved the engine trim threshold. Accordingly, the method may proceed to control the fuel cell assembly to bring the engine constraint within the first operability zone (process 1308). It should be appreciated that the fuel cell corrective action may be performed in concert with the turbomachine corrective action, as described above. For example, a determination that the engine constraint has achieved the engine trim threshold may trigger both fuel cell and turbomachine corrective actions.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

According to a first clause, a propulsion system for an aircraft is provided, the aircraft comprising an aircraft fuel supply, the propulsion system comprising: a fuel cell assembly comprising a fuel cell; a turbomachine comprising a compressor section, a combustor, and a turbine section arranged in serial flow order, the combustor configured to receive a flow of fuel and further configured to receive output products from the fuel cell; and a controller comprising a memory and one or more processors, the controller configured to: receive data indicative of an engine constraint of the turbomachine; determine that the engine constraint has achieved a fuel cell trim threshold; and perform a fuel cell corrective action with the fuel cell assembly in response to determining that the engine constraint has achieved the fuel cell trim threshold.

According to another clause, the controller is further configured to: determine that the engine constraint has not achieved an engine trim threshold; and perform the fuel cell corrective action with the fuel cell assembly in response to determining that the engine constraint has achieved the fuel cell trim threshold and that the engine constraint has not achieved the engine trim threshold.

According to another clause, the fuel cell trim threshold is indicative of at least one of: an engine fuel efficiency; an engine operability indicator; or an engine life indicator.

According to another clause, the engine trim threshold is indicative of a maximum predicted change in the engine constraint possible with a maximum capability of the fuel cell assembly.

According to another clause, the controller is further configured to modify operation of the fuel cell assembly in response to determining that the engine constraint has achieved the fuel cell trim threshold.

According to another clause, the controller comprises at least one of: a fuel cell power controller configured to modify operation of a fuel cell fuel actuator; or a current distribution controller configured to alter current distribution across the fuel cell assembly.

According to another clause, the controller further comprises a fuel cell fuel utilization controller, and wherein the fuel cell fuel utilization controller is configured to modify operation of the fuel cell fuel actuator as a prioritized response in response to determining that the engine constraint has achieved the fuel cell trim threshold.

According to another clause, the controller comprises a fuel cell temperature controller, and wherein the fuel cell temperature controller is configured to modify operation of a fuel cell bypass air actuator in response to the engine constraint achieving the fuel cell trim threshold.

According to another clause, the controller is further configured to: determine that the engine constraint has achieved an engine trim threshold; and perform a turbomachine corrective action with the turbomachine in response to the engine constraint achieving the engine trim threshold.

According to another clause, turbomachine corrective action comprises at least one of: adjusting an inlet guide vane assembly; or reducing a fuel supply to the turbomachine.

According to another clause, the propulsion system further comprises a plurality of actuation controllers configured to perform one or more corrective actions responsive to the engine constraint achieving the fuel cell trim threshold; and a priority controller configured to determine a priority sequence of the plurality of actuation controllers.

According to another clause, the priority controller is configured to determine the priority sequence of the plurality of actuation controllers based on a magnitude of deviation of the engine constraint from an engine trim threshold.

According to another clause, a method of operating a propulsion system for an aircraft is provided, the aircraft comprising an aircraft fuel supply and the propulsion system comprising a fuel cell assembly comprising a fuel cell and a turbomachine comprising a compressor section, a combustor, and a turbine section arranged in serial flow order, the method comprising: receiving, with the combustor, output products from the fuel cell and a flow of fuel; receiving, with a controller, data indicative of an engine constraint of the turbomachine; determining, with the controller, that the engine constraint has achieved a fuel cell trim threshold; and performing a fuel cell corrective action with the fuel cell assembly responsive to the engine constraint achieving the fuel cell trim threshold.

According to another clause, the method further comprises: determining, with the controller, that the engine constraint has achieved an engine trim threshold; and performing the fuel cell corrective action with the fuel cell assembly responsive to the engine constraint achieving the fuel cell trim threshold and not achieving the engine trim threshold.

According to another clause, the engine trim threshold is indicative of a maximum predicted change in the engine constraint possible with a maximum capability of the fuel cell assembly.

According to another clause, the method further comprises: determining that the engine constraint has achieved an engine trim threshold; and performing a turbomachine corrective action, with the turbomachine, responsive to determining that the engine constraint has achieved the engine trim threshold.

According to another clause, the turbomachine corrective action comprises at least one of: adjusting an inlet guide vane assembly; or reducing a fuel supply to the turbomachine.

According to another clause, the method further comprises: performing one or more corrective actions with a plurality of actuation controllers responsive to the engine constraint achieving the fuel cell trim threshold; and determining, with a priority controller, a priority sequence of the plurality of actuation controllers.

According to another clause, the method further comprises: determining the priority sequence of the plurality of actuation controllers with the priority controller based on a magnitude of deviation of the engine constraint from an engine trim threshold.

According to another clause, a priority controller for a propulsion system for an aircraft is provided, the propulsion system comprising a turbomachine and a fuel cell assembly, the priority controller comprising a processor and memory, the memory storing instructions that when executed by the processor cause the priority controller to perform instructions, the instructions including: receiving data indicative of an engine constraint of the turbomachine; determining if the engine constraint has achieved a fuel cell trim threshold; determining a priority sequence of a plurality of actuation controllers based on a magnitude of deviation; and transmitting a control signal to the fuel cell assembly to control at least one corrective action according to the priority sequence.

We claim:

1. A propulsion system for an aircraft, the aircraft comprising an aircraft fuel supply, the propulsion system comprising:
a fuel cell assembly comprising a fuel cell;
a turbomachine comprising a compressor section, a combustor, and a turbine section arranged in serial flow order, the combustor configured to receive a flow of fuel and further configured to receive output products from the fuel cell; and
a controller comprising a memory and one or more processors, the controller configured to:
receive data indicative of an engine constraint of the turbomachine;
determine that the engine constraint has achieved a fuel cell trim threshold; and
perform a fuel cell corrective action with the fuel cell assembly in response to determining that the engine constraint has achieved the fuel cell trim threshold.

2. The propulsion system of claim 1, wherein the controller is further configured to:
determine that the engine constraint has not achieved an engine trim threshold; and
perform the fuel cell corrective action with the fuel cell assembly in response to determining that the engine constraint has achieved the fuel cell trim threshold and that the engine constraint has not achieved the engine trim threshold.

3. The propulsion system of claim 2, wherein the engine trim threshold is indicative of a maximum predicted change in the engine constraint possible with a maximum capability of the fuel cell assembly.

4. The propulsion system of claim 1, wherein the fuel cell trim threshold is indicative of at least one of:
an engine fuel efficiency;
an engine operability indicator; or
an engine life indicator.

5. The propulsion system of claim 1, wherein the controller is further configured to modify operation of the fuel cell assembly in response to determining that the engine constraint has achieved the fuel cell trim threshold.

6. The propulsion system of claim 5, wherein the controller comprises at least one of:
a fuel cell power controller configured to modify operation of a fuel cell fuel actuator; or
a current distribution controller configured to alter current distribution across the fuel cell assembly.

7. The propulsion system of claim 6, wherein the controller further comprises a fuel cell fuel utilization controller, and wherein the fuel cell fuel utilization controller is configured to modify operation of the fuel cell fuel actuator as a prioritized response in response to determining that the engine constraint has achieved the fuel cell trim threshold.

8. The propulsion system of claim 5, wherein the controller comprises a fuel cell temperature controller, and wherein the fuel cell temperature controller is configured to modify operation of a fuel cell bypass air actuator in response to the engine constraint achieving the fuel cell trim threshold.

9. The propulsion system of claim 1, wherein the controller is further configured to:
determine that the engine constraint has achieved an engine trim threshold; and
perform a turbomachine corrective action with the turbomachine in response to the engine constraint achieving the engine trim threshold.

10. The propulsion system of claim 9, wherein turbomachine corrective action comprises at least one of:
adjusting an inlet guide vane assembly; or
reducing a fuel supply to the turbomachine.

11. The propulsion system of claim 1, further comprising:
a plurality of actuation controllers configured to perform one or more corrective actions responsive to the engine constraint achieving the fuel cell trim threshold; and
a priority controller configured to determine a priority sequence of the plurality of actuation controllers.

12. The propulsion system of claim 11, wherein the priority controller is configured to determine the priority sequence of the plurality of actuation controllers based on a magnitude of deviation of the engine constraint from an engine trim threshold.

13. A method of operating a propulsion system for an aircraft, the aircraft comprising an aircraft fuel supply and the propulsion system comprising a fuel cell assembly comprising a fuel cell and a turbomachine comprising a compressor section, a combustor, and a turbine section arranged in serial flow order, the method comprising:
receiving, with the combustor, output products from the fuel cell and a flow of fuel;
receiving, with a controller, data indicative of an engine constraint of the turbomachine;
determining, with the controller, that the engine constraint has achieved a fuel cell trim threshold; and
performing a fuel cell corrective action with the fuel cell assembly responsive to the engine constraint achieving the fuel cell trim threshold.

14. The method of claim 13, further comprising:
determining, with the controller, that the engine constraint has achieved an engine trim threshold; and
performing the fuel cell corrective action with the fuel cell assembly responsive to the engine constraint achieving the fuel cell trim threshold and not achieving the engine trim threshold.

15. The method of claim 14, wherein the engine trim threshold is indicative of a maximum predicted change in the engine constraint possible with a maximum capability of the fuel cell assembly.

16. The method of claim 13, further comprising:
determining that the engine constraint has achieved an engine trim threshold; and
performing a turbomachine corrective action, with the turbomachine, responsive to determining that the engine constraint has achieved the engine trim threshold.

17. The method of claim 16, wherein the turbomachine corrective action comprises at least one of:
adjusting an inlet guide vane assembly; or
reducing a fuel supply to the turbomachine.

18. The method of claim 13, further comprising:
performing one or more corrective actions with a plurality of actuation controllers responsive to the engine constraint achieving the fuel cell trim threshold; and
determining, with a priority controller, a priority sequence of the plurality of actuation controllers.

19. The method of claim 18, further comprising determining the priority sequence of the plurality of actuation controllers with the priority controller based on a magnitude of deviation of the engine constraint from an engine trim threshold.

20. A priority controller for a propulsion system for an aircraft, the propulsion system comprising a turbomachine and a fuel cell assembly, the priority controller comprising a processor and memory, the memory storing instructions that when executed by the processor cause the priority controller to perform instructions, the instructions including:
receiving data indicative of an engine constraint of the turbomachine;
determining if the engine constraint has achieved a fuel cell trim threshold;
determining a priority sequence of a plurality of actuation controllers based on a magnitude of deviation; and
transmitting a control signal to the fuel cell assembly to control at least one corrective action according to the priority sequence.
